(19) United States
(12) Patent Application Publication
(10) Pub. No.: US 2004/0161107 A1
(43) Pub. Date: Aug. 19, 2004

(54) AV data transmitter, AV data receiver, and AV data wireless communication system

(76) Inventor: Kazuya Oyama, Ikoma-Shi (JP)

Correspondence Address: BIRCH STEWART KOLASCH & BIRCH, PO BOX 747, FALLS CHURCH, VA, 22040-0747, US

(21) Appl. No.: 10/743,152

(22) Filed: Dec. 23, 2003

(30) Foreign Application Priority Data
Dec. 27, 2002 (JP) 2002-382348

(51) Int. Cl. H04N 7/167

(52) U.S. Cl. 380/200

(57) ABSTRACT

When an AV data transmitter transmits an ID changeover request signal for requesting ID code changeover, an AV data transmitter determines which AV data receiver requests the ID code changeover based on the received ID changeover request signal, changes over an ID code stored in the AV data transmitter to an ID code of the determined AV data receiver, encrypts AV data with the ID code thus changed, and transmits the encrypted AV data.

### BACKGROUND OF THE INVENTION

1. Field of the Invention

The present invention relates to an AV data transmitter which encrypts AV data with an encryption code and which transmits the encrypted AV data over wireless communication, an AV data receiver which receives encrypted AV data over wireless communication and which decodes the encrypted AV data, and an AV data wireless communication system which includes the AV data transmitter and the AV data receiver.

2. Description of the Prior Art

In recent years, an AV data wireless communication system in which AV data is transmitted to an AV reproduction apparatus such as a display or a projector from an AV source device such as a tuner, a video or a DVD and in which AV data is displayed or outputted in the form of a picture or a voice on or from the AV reproduction apparatus has been proposed following an increase in the complexity of wired connection and the development of wireless technology. To realize this AV data wireless communication system, an AV data transmitter which transmits the AV data is connected to the AV source device and an AV receiver is connected to the AV reproduction apparatus. Alternatively, this AV data transmitter is included in the AV source device and the AV data receiver is included in the AV reproduction apparatus, whereby the AV data wireless communication system is constituted by the AV source device and the AV reproduction apparatus.

In the AV data wireless communication system of this type, because of a copyright of the AV data, the AV data transmitter and the AV data receiver are provided in a one-to-one correspondence so that the AV data cannot be transmitted and received between an AV data transmitter and an AV data receiver that constitute another wireless communication system. FIG. 28 illustrates a configuration in that a plurality of conventional AV data wireless communication systems are employed.

In FIG. 28, two AV data wireless communication systems are provided. Among them, in one AV data wireless communications system X, AV data outputted from an AV source device 1 is transmitted from an antenna 511 of an AV data transmitter 101 connected to the AV source device 1 by a cable. This AV data from the AV source device 1 is received by an AV data receiver 102 through an antenna 541, supplied to an AV reproduction apparatus 2 connected to the AV data receiver 102 by a cable, and reproduced and displayed by the AV reproduction apparatus 2.

Further, when a remote controller 11 for operating the AV source device 1 is operated to transmit an infrared signal, the infrared signal is received by an infrared signal reception unit 553 in the AV data receiver 102, converted into a wireless communication signal, and transmitted from the antenna 541. When the AV data transmitter 101 receives this signal through the antenna 5 11, the AV data transmitter 101 converts the received signal into an infrared signal and transmits the infrared signal from an infrared signal transmission unit 517, an infrared signal reception unit 12 in the AV source device 1 receives the infrared signal, and the AV source device 1 performs an operation indicated by the remote controller 11.

Further, in the other AV data wireless communication system Y, when AV data is transmitted from an antenna 511 of an AV data transmitter 103 which has a function of an AV source device, an AV data receiver 104 which has a function of an AV reproduction apparatus receives the AV data through an antenna 541, projects the AV data, and reproduces and displays the projected AV data on a screen 13. When a remote controller 14 is operated to operate the AV data transmitter 103, an infrared signal reception unit 553 of the AV data receiver 104 receives an infrared signal, converts the infrared signal into a wireless communication signal, and transmits the wireless communication signal from the antenna 541. When the AV data receiver 103 receives this signal through the antenna 511, the AV receiver 103 performs an operation indicated by the remote controller 14.

As shown in FIG. 29, the AV data transmitter 101 includes an analog input unit 502 which inputs analog AV data such as an NTSC data and a digital input unit 501 which inputs a digital signal. The analog data is digitized by an A/D converter unit (hereinafter, referred to as “A/D”) 503 and encoded by an MPEG unit 504. Various types of data is put in order by a data generation unit 505, and an error correction code is added to the data by an error correction code addition unit 506. The data is encrypted (scrambled) by a data scramble unit 507, and transmitted toward the AV data receiver by way of a baseband (hereinafter, referred to as “BB”) 509, a radio frequency amplification circuit (hereinafter, referred to as “RF”) 510 and the antenna 511. An ID used when the data scramble unit 507 scrambles the data is stored in an ID storage unit 520. In the case where data to be inputted is digital data, the data is supplied from the digital input unit 501 directly to the data generation unit 505.

FIG. 30 illustrates the configuration of the AV data receiver 102, wherein the data is received through the antenna 541, an RF 542 and a BB 543, descrambled by a descramble unit 544, subjected to AV data sorting, shortage determination and the like by a data analysis unit 545, decoded by an MPEG unit 546, converted into an analog signal by a D/A conversion unit (hereinafter, referred to as “D/A”) 547, and outputted as data such as NTSC data from an analog output unit 548. An ID used when the descramble unit 544 descrambles the data is stored in an ID storage unit 560. In the case where digital data is to be outputted, the data from the data analysis unit 545 is outputted through a digital output analysis unit 549 and a digital output unit 550.

Further, in the AV data receiver 102, the data analysis unit 545 determines whether a data packet is correctly received. When the data analysis unit 545 determines that the data packet is not correctly received, a retransmission request packet generation unit 558 generates a retransmission request packet for the packet which is not received. The AV data receiver 102 further includes an operation unit 551 which inputs a signal for controlling the AV source device 1 and the infrared signal reception unit 553 which receives the infrared signal from the remote controller 11. The data from the operation unit 551 is converted by an operation unit data conversion unit 552, and a signal received by the infrared signal reception unit 553 is converted by a remote controller data conversion unit 554. A data generation unit 555 generates transmission data using a packet of the converted data and the retransmission request packet from the retransmission request packet generation unit 558. An error correction code addition unit 556 adds the error correction code to the transmission data thus generated. The resultant data is scrambled by a data scramble unit 557 and then transmitted to the AV data transmitter 101 through the BB 543, the RF 542 and the antenna 541.

When the AV data transmitter 101 receives the data through the antenna 511, the RF 510 and the BB 509, a descramble unit 512 descrambles the data, a data analysis unit 513 determines whether the AV data receiver 102 correctly receives a packet and put the data in order. In the case where a retransmission request is recognized, a retransmission request packet generation unit 514 generates a data packet of the AV data for which the retransmission request is issued. Further, the data which is obtained by the data analysis unit 513 and which operates the AV source device 1 is converted into a remote control signal by a remote controller data analysis unit 516, and transmitted as the infrared signal from the infrared signal transmission unit 517. Digital data other than the remote control signal is outputted from a digital data output unit 519 through a digital data analysis unit 518. 100111 The AV data transmitter 103 has the functions shown in FIG. 29 and also has the function of the AV source device 1. The AV data receiver 104 has the functions shown in FIG. 30 and also has the function of the AV reproduction apparatus 2.

In FIG. 28, an ID code recorded on the AV data transmitter 101 and the AV data receiver 102 that constitute the wireless communication system X is fixed to an ID code A. On the other hand, an ID code recorded on the AV data transmitter 103 and the AV data receiver 104 that constitute the wireless communication system Y is fixed to an ID code B. Therefore, the AV data can be transmitted between the AV data transmitter 101 and the AV receiver 102 equal in ID code over wireless communication. Likewise, the AV data can be transmitted between the AV data transmitter 103 and the AV data receiver 104 equal in ID code over wireless communication. The ID codes A and B given in the wireless communication systems X and Y are fixed to values set at the time of shipping, respectively.

Furthermore, there are proposed an electronic exchanger and a terminal which determine arrival orders of reception-side terminal devices based on IDs transmitted from transmission-side terminal devices and which perform a transmission processing according to the determined arrival orders (see Japanese Patent Application Laid Open No. H8-204828 (1996)).

In the AV data wireless communication system shown in FIG. 28, the AV data wireless transmission can be realized only by a preset combination of AV devices, which disadvantageously restricts a user from enjoying an arbitrary AV data source at an arbitrary location over wireless communication. In the case where a number of AV data receivers each capable of receiving the AV data encrypted by scrambling or the like and transmitted over wireless communication, descrambling the received AV data, and decoding the AV data are present simultaneously, many users can view or listen to the AV data using these AV data receivers. This, however, may possibly, disadvantageously infringe on a copyright of an AV source creator.

In order to hold wireless AV transmission while paying regard to the copyright of the AV source creator and that of a broadcasting company, the same encryption code is allocated to a predetermined number or less of AV data transmitters and receivers and the AV transmission is restricted so as to be able to be permitted only by a group consisting of the AV data transmitters and receivers allocated the same encryption code. By setting different encryption codes to different groups, respectively, the AV data transmission is restricted so as not to transmit the AV data among the groups. In addition, as shown in FIG. 28, in present situations, each group is constituted so that one of the AV data transmitters and one of the AV data receivers have the one-to-one correspondence.

If the group is constituted as shown in FIG. 28 and one user issues a request that the AV data transmitted from the AV source device 1 disposed in one room be reproduced by the AV data receiver 104 disposed in another room, the AV data receiver 102 and the AV reproduction apparatus 2 are turned off first. Thereafter, the AV data transmitter 103 is carried into the room where the AV source device 1 is disposed, the AV data transmitter 103 is connected to the AV source device 1, and the AV data from the AV source device 1 is reproduced by the AV data receiver 104.

The conventional constitution has the following disadvantages. In order for the user to view or listen to the same AV source even after the user moves from one room to another, a laborious processing for carrying the AV data receiver or preparing a plurality of sets of AV data transmission and reception systems and changing over one set of the AV data transmitter and receiver to another set should be carried out. Although it is possible to simultaneously activate a plurality of sets of AV data transmission and reception systems, this requires a plurality of AV data transmitters and receivers. Therefore, the number of installation locations and power consumption increase. Besides, since these plural transmitters and receivers simultaneously transmit and receive data, a large amount of a limited frequency band is occupied.

Further, with a method of setting the arrival orders of reception side terminal devices which perform the data arrival processings by the electronic exchanger in Japanese Patent Application Laid Open No. H8-204828 (1996), the orders of the terminal devices which perform the data arrival processing are determined based on the IDs transmitted from the transmission-side terminal devices and the reception-side terminal devices perform the data arrival processing according to the orders. Therefore, to select the AV data transmitter so as to transmit the AV data to the user's desired AV data receiver, it is disadvantageously necessary to turn off the AV data receivers higher in order than the user's desired AV receiver. Accordingly, in the case where the user desires the lowest-order AV data receiver, it is disadvantageously necessary to turn off all the other AV data receivers, which requires laborious processings and operations.

### SUMMARY OF THE INVENTION

The present invention has been achieved in view of these disadvantages. It is an object of the present invention to provide an AV data wireless communication system which enables an AV data receiver to request an AV data transmitter to transmit AV data. It is another object of the present invention to provide an AV data transmitter and an AV data receiver in the AV data wireless communication system.

In order to achieve the above object, the present invention provides an AV data transmitter comprising: a plurality of receiver key signals with each of which AV data including a voice and a picture is encrypted and each of which is set for each AV data receiver permitted to communicate with the AV data transmitter, wherein the AV data transmitter selects one of the receiver key signals according to the AV data receiver, to which the AV data transmitter is to transmit the AV data, from among the plurality of receiver key signals as a data communication key signal, encrypts the AV data with the selected data communication key signal, and transmits the AV data to the AV data receiver.

According to the AV data transmitter, when the AV data transmitter receives a changeover request signal for requesting that the data communication key signal be changed over to one of the receiver key signals according to the AV data receiver from the AV data receiver, the AV data transmitter determines that the AV data receiver which has transmitted the changeover request signal is the AV data receiver permitted to communicate with the AV data transmitter, and when the AV data receiver is the AV data receiver permitted to communicate with the AV data transmitter, the AV data transmitter changes over the receiver key selected as the data communication key signal to the one receiver key signal according to the AV data receiver and transmits the AV data encrypted with the correspondingly changed data communication key signal to the AV data receiver which has transmitted the changeover request signal.

The present invention also provides an AV data transmitter comprising: an encryption unit which encrypts AV data including a voice and a picture; a first key signal storage unit which stores a data communication key signal used when the encryption unit encrypts the AV data; a transmission/reception unit which transmits the AV data and which transmits/receives data; and a key signal changeover control unit which stores a plurality of receiver key signals set according to a plurality of AV data receivers permitted to communicate with the AV data transmitter, respectively, and which changes over a data communication key signal in the first hey signal storage unit wherein when the transmission/reception unit receives a changeover request signal for requesting that the data communication key signal be changed over to one of the receiver key signals according to one of the AV data receivers from the one AV data receiver, the AV data transmitter determines that the one AV data receiver which has transmitted the changeover request signal is one of the AV data receivers permitted to communicate with the AV data transmitter, and when the one AV data receiver is one of the AV data receivers permitted to communicate with the AV data transmitter, the key signal changeover control unit changes over the data communication key signal stored in the first key signal storage unit to the one receiver key signal according to the one AV data receiver. 100231 The present invention also provides an AV data receiver comprising: a receiver key signal with which received AV data that is transmitted from an AV data transmitter and that includes a voice and a picture is decrypted, wherein the AV data receiver transmits a changeover request signal for requesting that a key signal be changed over to the receiver key signal of the AV data receiver as a data communication key signal for encrypting the AV data, to the AV data transmitter which permits the AV data receiver to communicate with the AV data transmitter by storing the receiver key signal of the AV data receiver as one of a plurality of receiver key signals.

The present invention also provides an AV data receiver comprising: a transmission/reception unit which receives encrypted AV data such as a picture or a voice and which transmits/receives data; a first decryption unit which decrypts the AV data; a first key signal storage unit which stores a receiver key signal with which the first decryption unit decrypts the AV data; and a data generation unit which generates the data to be transmitted, wherein the data generation unit generates a changeover request signal for requesting that a key signal be changed over to the receiver key signal of the AV data receiver as a data communication key signal for encrypting the AV data, and the transmission/reception unit transmits the changeover request signal to the AV data transmitter which permits the AV data receiver to communicate with the AV data transmitter by storing the receiver key signal of the AV data receiver as one of a plurality of receiver key signals.

The present invention also provides an AV data wireless communication system comprising: an AV data transmitter which includes a plurality of receiver key signals with each of which AV data including a voice and a picture is encrypted and each of which is set for each AV data receiver permitted to communicate with the AV data transmitter, which selects one of the receiver key signals according to the AV data receiver to which the AV data transmitter is to transmit the AV data from among the plurality of receiver key signals as a data communication key signal, which encrypts the AV data with the selected data communication key signal, and which transmits the AV data to the AV data receiver; and an AV data receiver which decrypts the AV data to be received.

### DESCRIPTION OF THE DRAWINGS

This and other objects and features of the present invention will become clear from the following description, taken in conjunction with the preferred embodiments with reference to the accompanying drawings in which:

FIG. 1 is an illustration for describing an AV data wireless communication system according to the present invention;

FIG. 2 is a block diagram which illustrates the internal configuration of an AV data transmitter in first to fifth embodiments of the present invention;

FIG. 3 is an illustration for describing a transmission period of an AV data signal and a data signal according to the present invention;

FIG. 4 is a flowchart which illustrates an operation of the AV data transmitter during an ID changeover processing in the first embodiment;

FIGS. 5A to 5E illustrate an example of the state transition of the AV data wireless communication system in the first embodiment;

FIG. 6 is a flowchart which illustrates an operation of the AV data transmitter during an ID changeover processing in the second embodiment;

FIG. 7 is a block diagram which illustrates the internal configuration of an AV data receiver in the third to fifth embodiments of the present invention;

FIG. 8 is a flowchart which illustrates an operation of the AV data transmitter during a processing after the ID changeover processing in the third embodiment;

FIG. 9 is a flowchart which illustrates an operation of the AV data receiver during a power OFF processing in the third embodiment;

FIG. 10 is a flowchart which illustrates an operation of the AV data receiver during a power ON processing in the third embodiment;

FIGS. 11A to 11E illustrate an example of the state transition of the AV data wireless communication system in the third embodiment;

FIG. 12 is a flowchart which illustrates an operation of the AV data transmitter during an ID changeover determination processing in the fourth embodiment;

FIG. 13 is a flowchart which illustrates an operation of the AV data receiver during an ID changeover determination processing in the fourth embodiment;

FIGS. 14A to 14D illustrate states of the AV data receiver when the AV data receiver transmits an ID changeover determination signal in the fourth embodiment;

FIGS. 15A to 15D illustrate display examples of the AV reproduction apparatus when the AV data receiver transmits the ID changeover determination signal in the fourth embodiment;

FIG. 16 is a flowchart which illustrates another example of the operation of the AV data transmitter during the ID changeover determination processing in the fourth embodiment;

FIG. 17 is a flowchart which illustrates an operation of the AV data transmitter during an ID changeover determination processing in the fifth embodiment;

FIG. 18 is a flowchart which illustrates an operation of the AV data receiver during the ID changeover determination processing in the fifth embodiment;

FIGS. 19A and 19B illustrate display examples of the AV reproduction apparatus when a changeover permission signal or a changeover prohibition signal is received in the fifth embodiment;

FIG. 20 is a block diagram which illustrates the internal configuration of an AV data transmitter in a sixth embodiment of the present invention;

FIG. 21 is a block diagram which illustrates the internal configuration of an AV data receiver in the sixth embodiment of the present invention;

FIG. 22 is a flowchart which illustrates an ID changeover operation of the AV data transmitter in the AV data wireless communication system in the sixth embodiment;

FIG. 23 is a block diagram which illustrates the internal configuration of an AV data transmitter in a seventh embodiment of the present invention;

FIG. 24 is a block diagram which illustrates the internal configuration of an AV data receiver in the seventh embodiment of the present invention;

FIG. 25 is a flowchart which illustrates an ID changeover operation of the AV data transmitter in the AV data wireless communication system in the seventh embodiment;

FIG. 26 is a block diagram which illustrates the internal configuration of an AV data receiver in an eighth embodiment of the present invention;

FIG. 27 is a flowchart which illustrates an ID change operation of the AV data transmitter in the AV data wireless communication system in the eighth embodiment;

FIG. 28 is an illustration for describing a conventional AV data wireless communication system;

FIG. 29 is a block diagram which illustrates the internal configuration of a conventional AV data transmitter; and

FIG. 30 is a block diagram which illustrates the internal configuration of a conventional AV data receiver.

### DESCRIPTION OF THE PREFERRED EMBODIMENTS

### First Embodiment

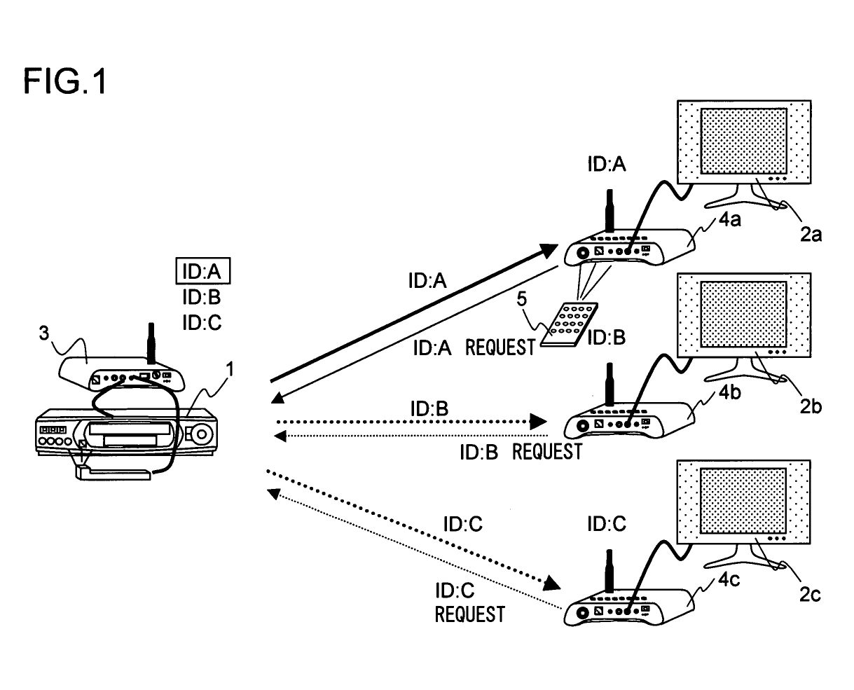

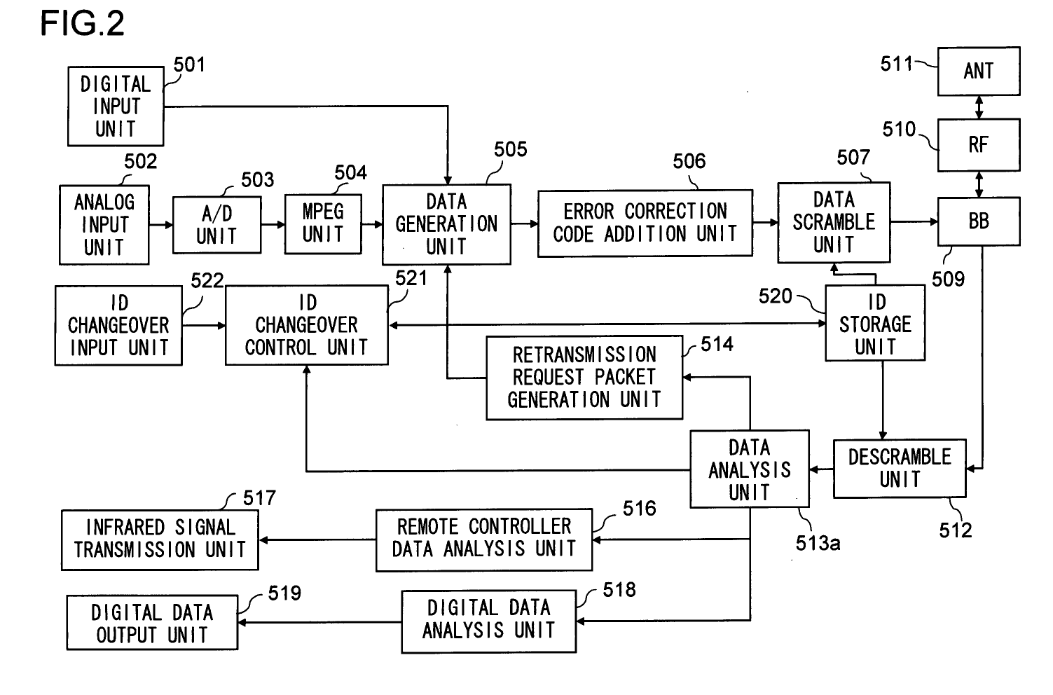

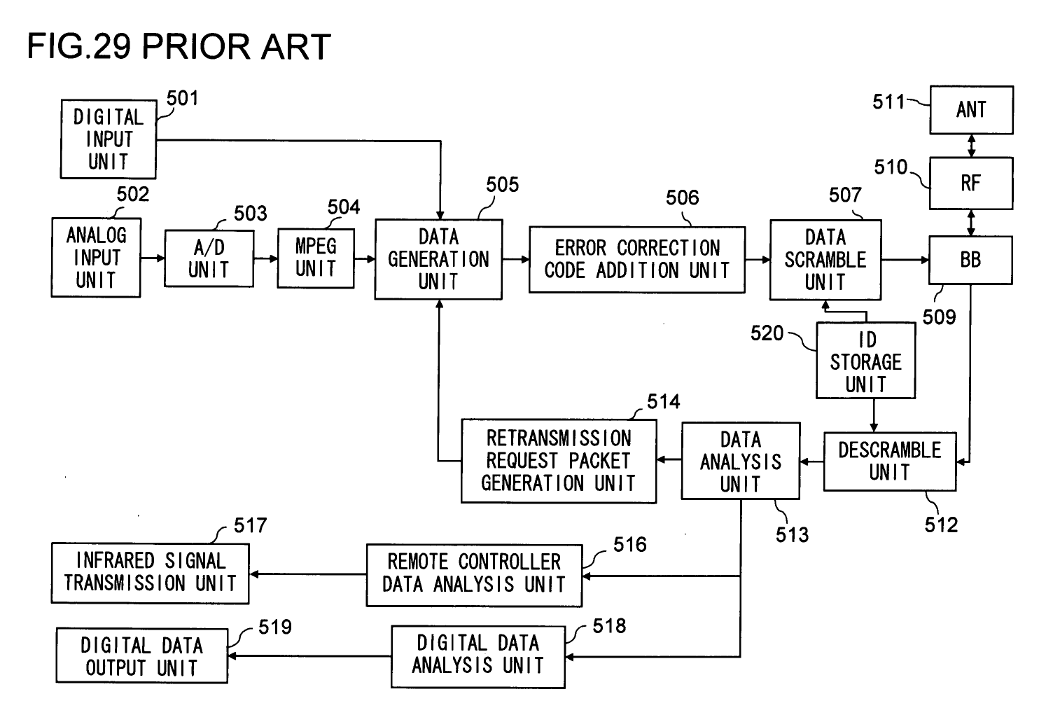

Hereinafter, a first embodiment of the present invention will be described with reference to the drawings. FIG. 1 is an illustration for describing an AV data wireless communication system in the first embodiment. FIG. 2 is a block diagram which illustrates the internal configuration of an AV data transmitter. In FIG. 2, the same constituent elements as those shown in FIG. 29 are denoted by the same reference symbols, respectively, and will not be described herein in detail.

The AV data wireless communication system shown in FIG. 1 is constituted by: an AV data transmitter 3 which records ID codes A to C and which is connected to an AV source device 1 by a cable; an AV data receiver 4a which records the ID code A and which is connected to an AV reproduction apparatus 2a by a cable; an AV data receiver 4b which records the ID code B and which is connected to an AV reproduction apparatus 2b by a cable; an AV data receiver 4c which records the ID code C and which is connected to an AV reproduction apparatus 2c by a cable; and a remote controller 5 which operates the AV data receivers 4a to 4c.

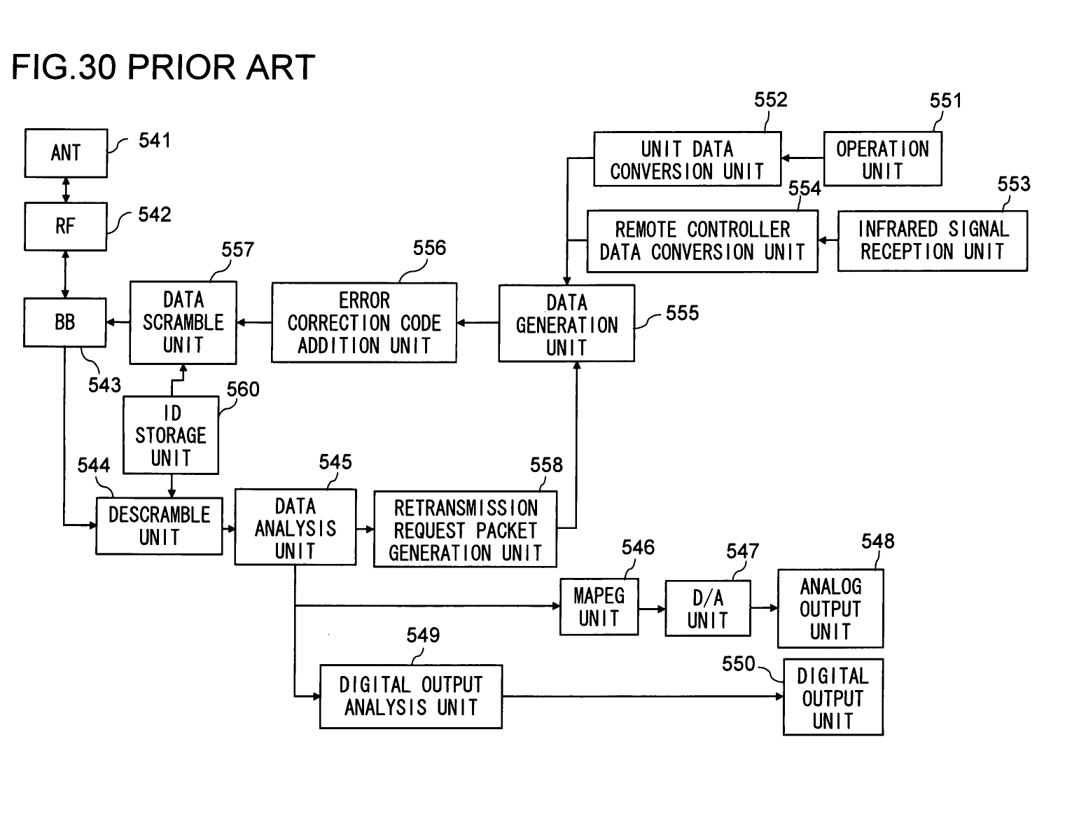

As shown in FIG. 2, the AV data transmitter 3 in this embodiment is equal in configuration to the AV data transmitter shown in FIG. 29 except that the AV data transmitter 3 additionally includes an ID changeover control unit 521 which records a plurality of ID codes and which changes over an ID code recorded on an ID storage unit 520 to another ID code and an ID changeover input unit 522 which receives a command of ID code changeover from an external device, and that the AV data transmitter 3 includes a data analysis unit 513a having a function of issuing an ID code changeover request in addition to the function of the data analysis unit 513. Thus, the AV data transmitter 3 shown in FIG. 1 has the ID codes A to C included in the ID changeover control unit 521. Each of the AV data receivers 4a to 4c in this embodiment is equal in configuration to the conventional AV data receiver as shown in FIG. 30.

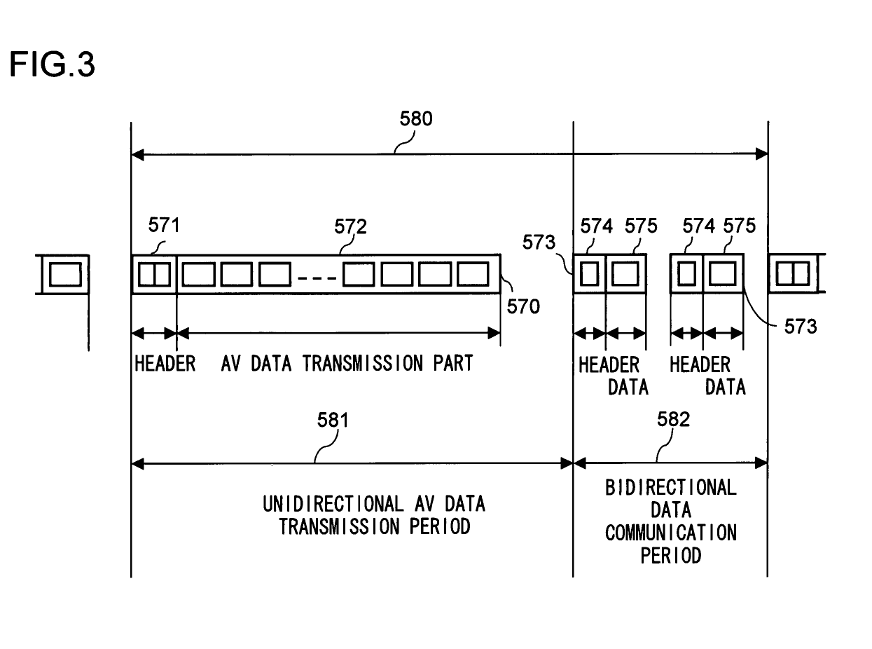

In the AV data wireless communication system shown in FIG. 1, therefore, the AV data transmitter 3 is constituted as shown in FIG. 2 and each of the AV data receivers 4a to 4c is constituted as shown in FIG. 30. An example of a data communication format of the AV data wireless communication system thus constituted will be described with reference to a time chart of FIG. 3. As shown in the time chart of FIG. 3, one data communication period 580 includes a unidirectional AV data transmission period 581 in which the AV data transmitter 3 transmits AV data and a bidirectional data communication period 582 in which mutual data communication is held between the AV data transmitter 3 and the AV data receivers 4a to 4c.

In the AV data transmission period 581, only the AV data transmitted from the AV data transmitter 3 is transmitted and received. In this AV data transmission period 581, the AV data receiver 4 (corresponding to one of the AV data receivers 4a to 4c) permitted to communicate with the AV data transmitter 3 receives an AV data signal 570 which is transmitted from the AV data transmitter 3 and be constituted by a transmission header 571 which indicates a sender, a destination and the like, and an AV data transmission part 572 which is stream data. In this AV data transmission period 581, the AV data signal 570 may include a plurality of pieces of AV data, or a plurality of AV data signals 570 may be transmitted.

In the bidirectional data communication period 582, data signals 573 each of which is constituted by a transmission header 574 indicating a sender, a destination and the like, and data 575 such as various control signals are freely transmitted and received between the AV data transmitter 3 and the AV data receivers 4a to 4c similarly to a LAN (Local Area Network) communication. In this period, the AV data transmitter 3 transmits as the data signal 573, for example, control signals for controlling operations of the AV data receivers 4a to 4c and the AV reproduction apparatuses 2a to 2c. In addition, each of the AV data receivers 4a to 4c transmits as the data signal 573 an ID code changeover request or an AV data retransmission request to the AV data transmitter 3 or a control signal for controlling the AV source device. [00331 When the AV data transmission period 581 and the bidirectional data communication period 582 are thus set, the AV data signal 570 and the data signal 573 transmitted from the AV data transmitter 3 are encrypted with an ID code according to the AV data receiver 4 with which the AV data transmitter 3 currently communicates. Further, the data signals transmitted from the AV data receivers 4a to 4c are encrypted with the ID codes A to C stored therein, respectively. It is noted that the data communication format shown in FIG. 3 is given only for illustrative purposes and the other data communication format may be used in the AV data wireless communication system.

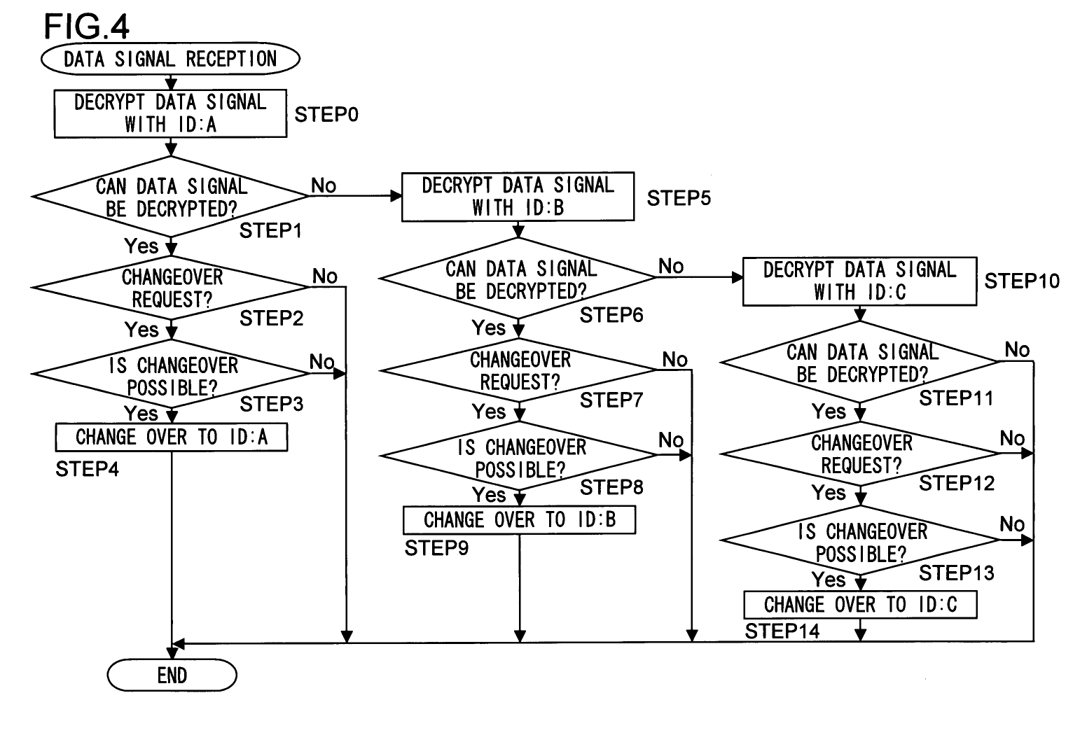

Supposing that the data communication period of the AV data wireless communication system shown in FIG. 1 is thus set, the ID code changeover operation of the AV data wireless communication system will be described with reference to a flowchart of FIG. 4. In this ID code changeover operation, the control signal is inputted to each of the AV data receivers 4a to 4c by operating the remote controller 5, and the ID code changeover request is transmitted to the AV data transmitter 3 from each of the AV data receivers 4a to 4c.

In the bidirectional data communication period 582, when the AV data transmitter 3 receives the data signal 573, the received data signal 573 is transmitted to the descramble unit 512 through the antenna 511, the RF 510 and the BB 509. When the data signal 573 is transmitted to the descramble unit 512, the data analysis unit 513a requests the ID changeover control unit 521 to allocate the ID code A, and the ID changeover control unit 521 feeds the ID code A to the ID storage unit 520. The descramble unit 512 then decrypts the data signal 573 with the ID code A (STEP 0).

When a result of decrypting the data signal 573 is fed to the data analysis unit 513a, the data analysis unit 513a determines whether the data signal 573 is decrypted with the ID code A (STEP 1). When it is determined that the data signal 573 is decrypted with the ID code A (Yes in STEP 1), the data analysis unit 513a determines whether the decrypted data signal 573 is a ID changeover request signal for converting the ID code used when the AV data is transmitted and received into the ID code A (STEP 2). When it is determined that the decrypted data signal 573 is the ID changeover request signal (Yes in STEP 2), the data analysis unit 513a determines whether the ID changeover control unit 521 permits the ID code changeover (STEP 3).

In the case where a user is viewing or listening to a content of the AV data from the AV source device 1 or the ID code is already changed over once after the start of the present bidirectional data communication period 582, the ID changeover control unit 521 prohibits the ID code changeover. When it is determined that the ID changeover control unit 521 permits the ID code changeover (Yes in STEP 3), the ID changeover control unit 521 changes over or fixes the ID code to the ID code A stored in the ID storage unit 520, and prohibits further ID code changeover so that the ID code A is not changed over to the other ID code when the AV data transmitter 3 receives another ID changeover request signal in the present bidirectional data communication period 582 (STEP 4).

When it is determined that the data signal 573 is not decrypted with the ID code A (No in STEP 1), the data analysis unit 513a requests ID code changeover from the ID code A to the ID code B, the ID code changeover control unit 521 changes over the ID code stored in the ID storage unit 520 to the ID code B and the data signal 573 is decrypted with the ID code B (STEP 5).

Similarly to the steps for the ID code A, the data analysis unit 513a determines whether the data signal 573 is decrypted with the ID code B (STEP 6). When it is determined that the data signal 573 is decrypted with the ID code B (Yes in STEP 7), the data analysis unit 513a determines whether the decrypted data signal 573 is the ID changeover request signal (STEP 7). When it is determined that the decrypted data signal 573 is the ID changeover request signal (Yes in STEP 6), the data analysis unit 513a determines whether the ID changeover control unit 521 permits the ID code changeover (STEP 8). When it is determined that the ID changeover control unit 521 permits the ID code changeover (Yes in STEP 8), the ID changeover control unit 521 changes over or fixes the ID code in the ID storage unit 520 to the ID code B, and prohibits further ID code changeover (STEP 9).

When it is determined in STEP 6 that the data signal 573 is not decrypted with the ID code B, the ID code changeover control unit 521 changes over the ID code stored in the ID storage unit 520 to the ID code C, and the data signal 573 is decrypted with the ID code C (STEP 10). Similarly to the steps for the ID code A, the data analysis unit 513a determines whether the data signal 573 is decrypted with the ID code C in STEP 11, whether the decrypted data signal 573 is the ID changeover request signal in STEP 12, and whether the ID changeover control unit 521 permits the ID code changeover in STEP 13. When it is determined that the data signal 573 decrypted with the ID code C is the ID changeover request signal and that the ID code changeover is permitted, the ID changeover control unit 521 changes over or fixes the ID code in the ID storage unit 520 to the ID code C, and prohibits further ID code changeover (STEP 14).

When the ID code changeover control unit 521 changes over the ID code in STEP 4, STEP 9 or STEP 14, when the data analysis unit 513a determines that the decrypted data signal 573 is not the ID changeover request signal (No) in STEP 2, STEP 7 or STEP 12, when the data analysis unit 513a determines that the ID changeover control unit 521 prohibits the ID code changeover (No) in STEP 3, STEP 8 or STEP 13, or when the data analysis unit 513a determines that the data signal 573 is not decrypted with the ID code C (No) in STEP 11, the ID code changeover operation is finished.

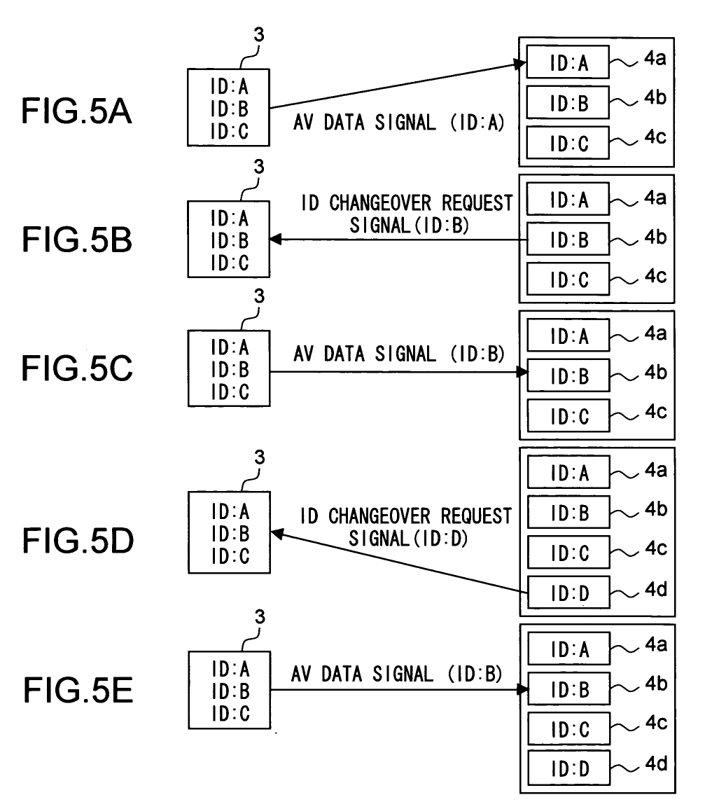

FIGS. 5A to 5E illustrate an example of the state transition of the AV data wireless communication system when the system performs the ID code changeover operation. First, as shown in FIG. 5A, when the AV data transmitter 3 encrypts the AV data signal 570 with the ID code A and transmits the encrypted AV data signal 570, only the AV data receiver 4a that stores the ID code A receives the AV data signal 570. Accordingly, the AV data receivers 4b and 4c are in data non-receivable states.

Thereafter, the unidirectional AV data transmission period 581 transits to the bidirectional data communication period 582. As shown in FIG. 5B, when the AV data receiver 4b transmits the data signal 573 encrypted with the ID code B and serving as the ID changeover request signal to the AV data transmitter 3, the AV data transmitter 3 decrypts the data signal 573 with the ID code B. Accordingly, the AV data transmitter 3 determines that the AV data receiver 4b that stores the ID code B requests the ID code changeover and allows the ID changeover control unit 521 to change over the ID code stored in the ID storage unit 520 to the ID code B. As shown in FIG. 5C, the AV data transmitter 3 transmits the AV data signal 570 and the data signal 573 both encrypted with the ID code B to the AV data receiver 4b.

While the AV data transmitter 3 and the AV data receiver 4b hold the AV data wireless communication therebetween as described above, when the AV data receiver 4d that stores the ID code D transmits the data signal 573 encrypted with the ID code D and serving as the ID changeover request signal to the AV data transmitter 3 as shown in FIG. 5D, the AV data transmitter 3 cannot decrypt the data signal 573 with any of the ID codes A to C. Accordingly, that the AV data transmitter 3 recognizes that the AV data receiver 4d is not the permitted receiver and the ID code stored in the ID storage unit 520 is, therefore, kept being the ID code B. As a result, as shown in FIG. 5E, the AV data transmitter 3 and the AV data receiver 4b can continue the AV data wireless communication therebetween.

As described above, according to the first embodiment, only the AV data receivers 4a to 4c including the ID codes A to C, respectively, managed by the AV data transmitter 3 are permitted to hold the AV data wireless communication with the AV data transmitter 3. In addition, the AV data wireless communication can be started in response to the request from each of the AV data receivers 4. Further, by operating the ID changeover input unit 522, the ID changeover control unit 521 changes over the ID code stored in the ID storage unit 520 to the other ID code.

In the first embodiment, the AV data transmitter determines that the ID code changeover request is issued by the ID changeover request signal from each AV data receiver. Alternatively, by receiving the data signal transmitted from one of the AV data receivers in the bidirectional data communication period, the AV data transmitter may determine that the ID code changeover request is issued. In this case, the operations in STEP 2, STEP 7 and STEP 12 in the flowchart of FIG. 4 can be omitted.

### Second Embodiment

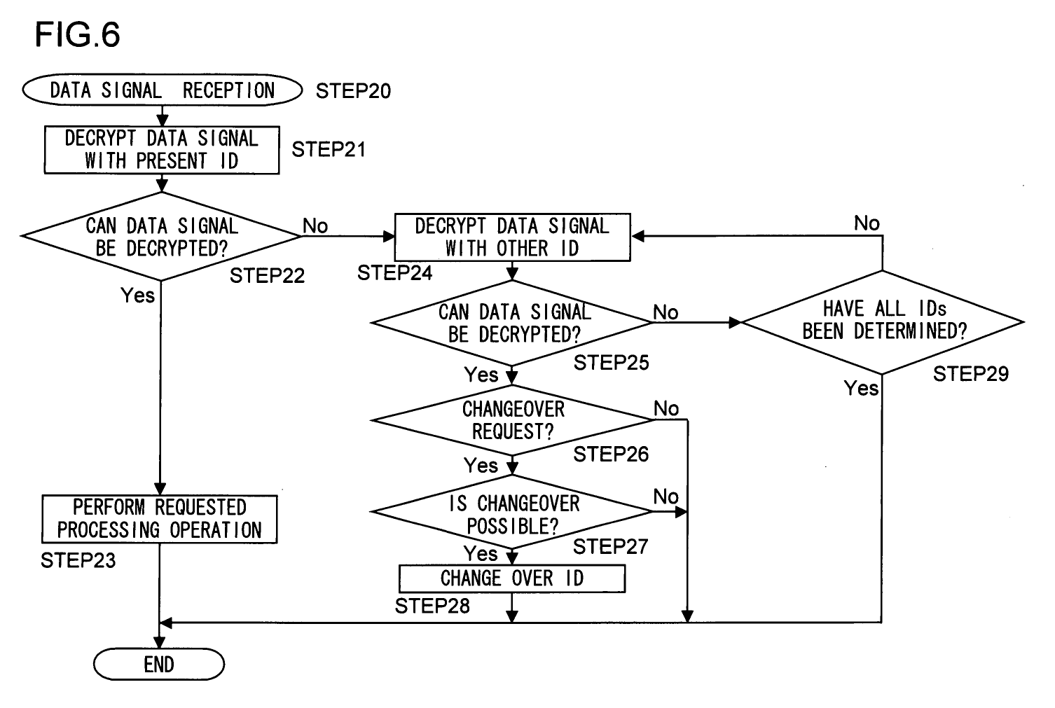

Hereinafter, a second embodiment of the present invention will be described with reference to the drawings. An AV data wireless communication system, an AV data transmitter and an AV data receiver in this embodiment are constituted as shown in FIGS. 1, 2 and 30, respectively, similarly to the first embodiment. In this embodiment, therefore, an ID changeover operation different from that in the first embodiment will be described with reference to a flowchart shown in FIG. 6.

In the bidirectional data communication period 582, when the AV data transmitter 3 receives the data signal 573 (STEP 20), the descramble unit 512 decrypts the data signal 573 with the ID code currently stored in the ID storage unit 520 and transmits the decryption result to the data analysis unit 513a (STEP 21). The data analysis unit 513a determines whether the data signal 573 is decrypted with the present ID code (STEP 22).

When the data analysis unit 513a determines that the data signal 573 is decrypted with the present ID code (Yes in STEP 22), a processing operation requested by the data signal 573 is carried out (STEP 23). Namely, since the data signal 573 is outputted from the AV data receiver 4 (corresponding to one of the AV data receivers 4a to 4c) which is now holding AV data communication with the AV data transmitter 3, the data signal 573 serves as either the AV data retransmission request signal or the control signal for controlling the operation of the AV source device 1. Therefore, the AV data transmitter 3 carries out an AV data retransmission processing, a control processing for controlling the AV source device 1 or the like and finishes the ID changeover operation.

When the data analysis unit 513a determines that the data signal 573 is not decrypted with the ID code stored in the ID storage unit 520 (No in STEP 22), the data analysis unit 513a issues an ID code changeover request, the ID changeover control unit 521 changes over the ID code stored in the ID storage unit 520 to another ID code, and the data signal 573 is decrypted with the changed ID code (STEP 24). The data analysis unit 513a determines whether the data signal 573 is decrypted with the changed ID code (STEP 25).

When it is determined that the data signal 573 is decrypted (Yes in STEP 25), the data analysis unit 513a determines whether the decrypted data signal 573 is the ID changeover request signal for changing over the ID code used when the AV data is transmitted and received to another ID code (STEP 26). When the data analysis unit 513a determines that the decrypted data signal 573 is the ID changeover request signal (Yes in STEP 26), the data analysis unit 513a determines whether the ID changeover control unit 521 permits the ID code changeover (STEP 27).

When it is determined that the ID changeover control unit 521 permits the ID code changeover (Yes in STEP 27), the ID changeover control unit 521 changes over or fixes the ID code changed and stored in the ID storage unit 520 in STEP 24 to another ID code, and prohibits further ID code changeover so that the ID code is not changed over to the other ID code when the AV data transmitter 3 receives another ID changeover request signal in the present bidirectional data communication period 582 (STEP 28).

When it is determined that that the data signal 573 is not decrypted with the changed ID code (No in STEP 25), it is determined whether the data signal 573 has been decrypted with any of all the ID codes recorded by the ID changeover control unit 521 (STEP 29). When the ID changeover control unit 521 determines that there is an ID code which is not used yet, the ID code stored in the ID storage unit 520 in STEP 24 is changed over to the unused ID code and the data signal 573 is decrypted with the changed, unused ID code.

When the AV data transmitter 3 operates according to the flowchart of FIG. 6, performs the operation based on the data signal 573 in STEP 23, determines that the data signal 573 is not the ID changeover request signal (No in STEP 26), determines that the ID code can be changed over (No in STEP 27), changes over the ID code to another ID code in STEP 28, or determines that the data signal 573 has been decrypted with any of all the ID codes recorded by the ID changeover control unit 521 (Yes in STEP 29), the AV data transmitter 3 finishes the ID changeover operation.

As described above, according to the second embodiment, differently from the first embodiment, the data signal is decrypted with the ID code currently stored in the ID storage unit 520 first. Namely, when the AV data transmitter 3 which includes the ID codes A to C receives the data signal 573 while the ID code B is stored in the ID storage unit 520, the data signal is decrypted with the ID code B first. When the data signal can be decrypted, it is determined that the data signal 573 is outputted from the AV data receiver 4b with which the AV data transmitter 3 holds the data communication and the ID changeover operation can be, therefore, omitted. Conversely, when the data signal cannot be decrypted with the ID code B, the ID code B is changed over to the other ID code A or C and the data signal is decrypted with the changed ID code and it can be determined whether the ID changeover request is issued. Therefore, in the second embodiment, differently from the first embodiment, it is unnecessary to carry out decryption for all the ID codes, making it possible to simplify the operation.

In this embodiment, similarly to the first embodiment, the AV data transmitter may determine that the ID code changeover request is issued by receiving the data signal transmitted from the AV data receiver in the bidirectional data communication period, and the operation in STEP 26 in the flowchart of FIG. 6 may be omitted. Further, even when the AV data transmitter carries out the ID changeover operation as described in this embodiment, similarly to the first embodiment, the state transition shown in the example of FIGS. 5A to 5E is made.

### Third Embodiment

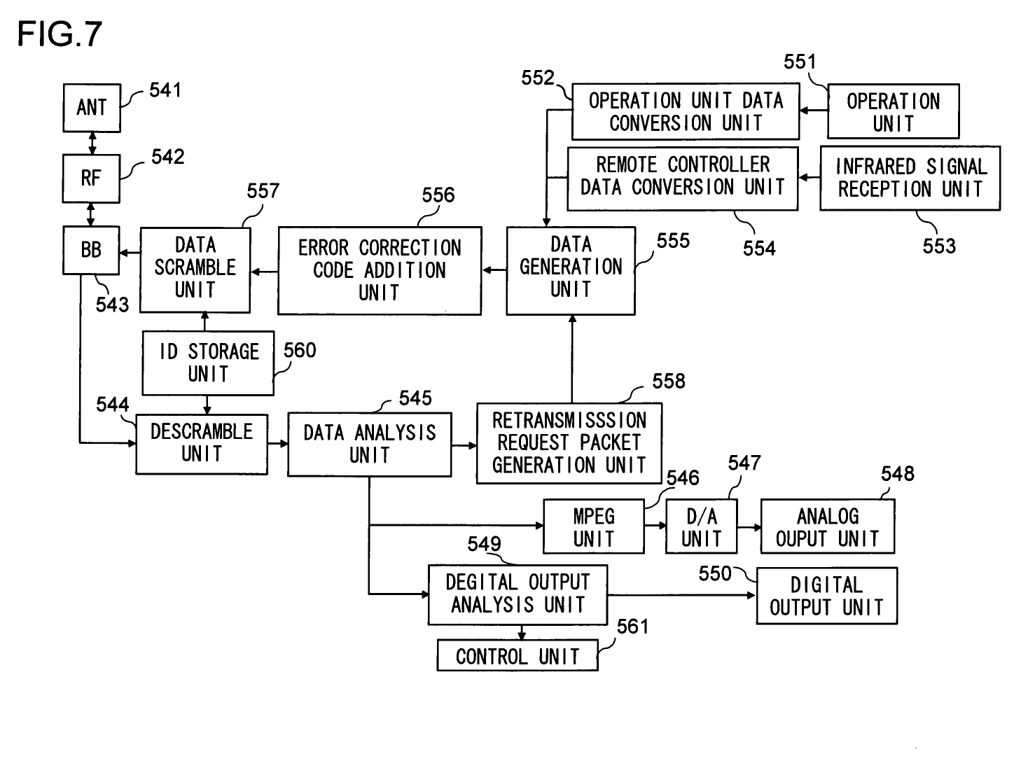

Hereinafter, a third embodiment of the present invention will be described with reference to the drawings. An AV data wireless communication system and an AV data transmitter in this embodiment are constituted as shown in FIGS. 1 and 2, respectively, similarly to the first embodiment. An AV data receiver is constituted as shown in a block diagram of FIG. 7.

As shown in FIG. 7, the AV data receiver in this embodiment differs from the AV data receiver shown in FIG. 30 in that the AV data receiver includes a control unit 561 which can control external devices such as the AV reproduction apparatus or an AC power supply connected to the AV data receiver. This control unit 561 is fed with a control signal for controlling the external device determined when the digital output analysis unit 549 performs an operation and controls the external device based on the control signal.

In the AV data wireless communication system in this embodiment, differently from the first and second embodiments, when the ID code stored in the ID storage unit 520 is to changed, the AV data receiver 4 (corresponding to one of the AV data receivers 4a to 4c) which received the AV data signal 570 transmitted before the change of the ID code from the AV data transmitter 3 is turned off. In the AV data wireless communication system in this embodiment, the same ID changeover operation as that in the first or second embodiment is carried out. That is, when the ID changeover request is issued from the AV data receiver 4 which includes the ID code other than the currently set ID code, the AV data transmitter 3 carries out the ID changeover operation according to the flowchart of FIG. 4 or FIG. 6.

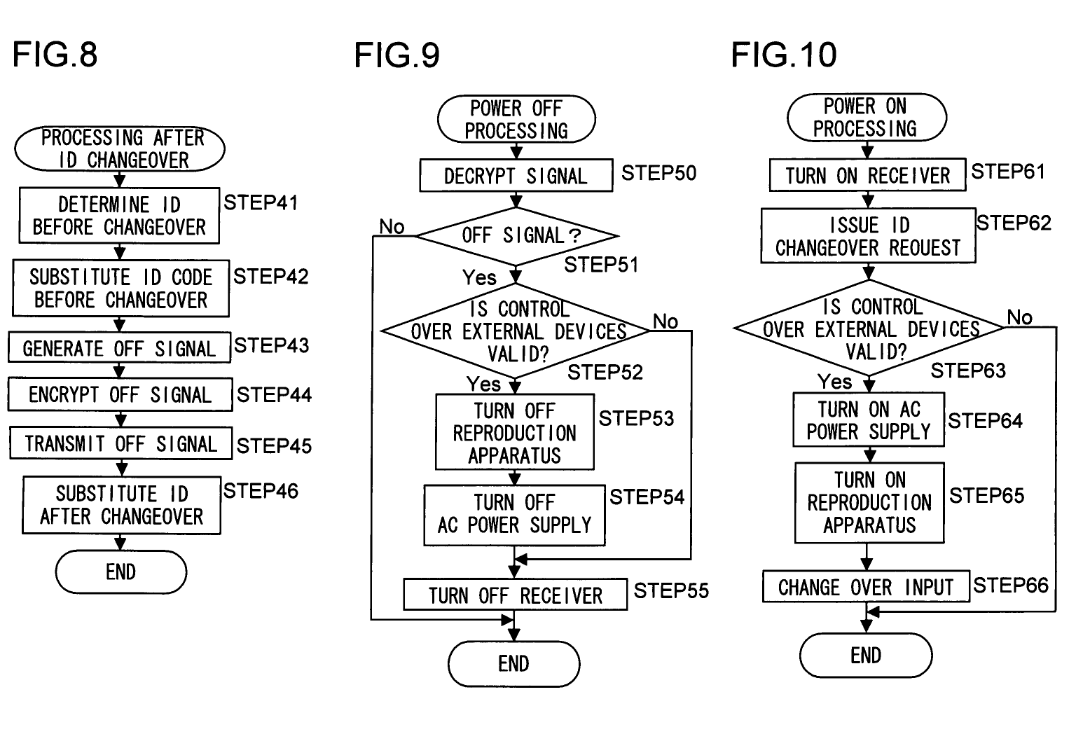

As described above, by allowing the AV data transmitter 3 to carry out the ID changeover operation, the ID code stored in the ID storage unit 520 in the AV data transmitter 3 is changed and AV data wireless communication is to be held using the changed ID code. At this moment, the ID code stored in the ID storage unit 520 and used for encryption before the changeover is stored in the ID changeover control unit 521. Thereafter, the AV data transmitter 3 operates according to a flowchart of FIG. 8.

The operation of the AV data transmitter 3 at this moment will be described. First, the ID code used before the ID code stored in the ID changeover control unit 521 is changed (hereinafter, referred to as “ID code before changeover”) is determined (STEP 41). The ID changeover control unit 521 temporarily substitutes the ID code stored in the ID storage unit 520 after the ID changeover operation is finished (hereinafter, referred to as “ID code after changeover”) for the determined ID code before changeover (STEP 42). At this moment, therefore, a recording state of the ID storage unit 520 temporarily turns into a state before the ID changeover operation in the flowchart of FIG. 4 or 6.

After the data generation unit 505 generates the control signal for turning off the AV data receiver 4 (hereinafter, referred to as “OFF signal”), the error correction code addition unit 506 adds an error correction code to this OFF signal (STEP 43). Thereafter, the data scramble unit 507 reads out the ID code before changeover temporarily substituted and stored in the ID storage unit 520 and encrypts the error correction code-added OFF signal (STEP 44).

Thus, the OFF signal encrypted with the ID code before changeover is transmitted through the BB 509, the RF 510 and the antenna 511 (STEP 45). When this OFF signal has been transmitted, the ID changeover control unit 521 returns the ID code stored in the ID storage unit 520 to the ID code after changeover set in the ID changeover operation in the flowchart of FIG. 4 or 6 (STEP 46).

When such an OFF signal is received by the AV data receiver 4 which stores the ID code before changeover, the AV data receiver 4 performs a power OFF processing according to a flowchart of FIG. 9. In this processing, the signal received through the antenna 541, the RF 542 and the BB 543 is fed to the descramble unit 544, the signal is decrypted with the ID code stored in the ID storage unit 560, and then the data analysis unit 545 analyzes a content of the received signal (STEP 50).

The data analysis unit 545 determines whether the received signal is an OFF signal (STEP 51). When the data analysis unit 545 determines that the received signal is the OFF signal (Yes in STEP 51), the control unit 561 determines whether control over the external devices such as the AV reproduction apparatus 2 (corresponding to one of the AV reproduction apparatuses 2a to 2c) and the external AC power supply connected to the AV data receiver 4 is valid (STEP 52). When it is determined that control over the operations of the external devices is valid (Yes in STEP 52), the OFF signal is applied to the control unit 561 through the digital output analysis unit 549 and the control unit 561 controls the AV reproduction apparatus 2 to be turned off (STEP 53). Thereafter, the control unit 561 controls the external AC power supply to be turned off (STEP 54).

When the AV reproduction apparatus 2 is thus turned off or when it is determined that the control over the operations of the external devices is invalid (No in STEP 52), the AV data receiver 4 itself is turned off (STEP 55) and the AV data receiver 4 finishes the operation when receiving the OFF signal. When it is determined that the received signal is not the OFF signal (No in STEP 51), the AV data receiver 4 finishes the operation. In this operation in the flowchart of FIG. 9, the control operation for turning off the AC power supply in STEP 54 may be omitted or the AV reproduction apparatus 2 may be turned off by directly turning off the AC power supply without the control operation for turning off the AV reproduction apparatus 2 in STEP 53.

Further, in the AV data wireless communication system in this embodiment, when the AV data receiver 4 is turned on by operating the remote controller 5 or being directly operated, the AV data receiver 4 issues an ID code changeover request to change over the ID code stored in the ID storage unit 520 of the AV data transmitter 3 to the ID code stored in the AV data receiver 4 so as to receive the AV data signal 570 from the AV data transmitter 3. The operation of the AV data receiver 4 when being turned on will now be described with reference to a flowchart of FIG. 10.

When the AV data receiver 4 is turned on (STEP 61), the data generation unit 555 generates the ID changeover request signal for indicating the ID code stored in the ID storage unit 520 of the AV data transmitter 3 to be changed over to the ID code stored in the ID storage unit 560 of the AV data receiver 4, and transmits the generated ID changeover request signal to the AV data receiver 4 through the BB 543, the RF 542 and the antenna 541 (STEP 62). At this time, the error correction code is added to the ID changeover request signal by the error correction code addition unit 556, encrypted with the ID code stored in the ID storage unit 560 by the data scramble unit 557, and transmitted to the AV data transmitter 3.

Accordingly, the AV data transmitter 3 that receives this ID changeover request signal carries out the ID changeover operation according to the flowchart of FIG. 4 or FIG. 6. In addition, in the AV data receiver 4, the control unit 561 determines whether the control operation for control over the external devices such as the AV reproduction apparatus 2 and the AC power supply connected to the AV data receiver 4 is valid after transmission of the ID changeover request signal (STEP 63). When it is determined that the operations of the external devices can be controlled (Yes in STEP 63), the control unit 561 controls the external AC power supply to be turned on (STEP 64).

Next, after the control unit 561 controls the AV reproduction apparatus 2 to be turned on (STEP 65), the AV reproduction apparatus 2 is changed to a data input state so as to be able to input the AV data from the analog output unit 548 to the AV reproduction apparatus 2 (STEP 66). When the input of the AV reproduction apparatus 2 is changed over or when it is determined that the operation of the AV reproduction apparatus 2 cannot be controlled (No in STEP 63), the AV data receiver 4 finishes the processing operation during power ON.

Consequently, only by turning on the AV data receiver 4, the ID changeover request can be issued to the AV data transmitter 3 and the AV reproduction apparatus 2 can be activated. Alternatively, the ID changeover request operation in STEP 62 may be carried out after the activation control over the AV reproduction apparatus 2 in STEP 63 to STEP 66. Further, the external devices such as the AV reproduction apparatus 2 and the AV power supply may be controlled only by turning on a power supply function of the AV reproduction apparatus 2 without turning on the AC power supply.

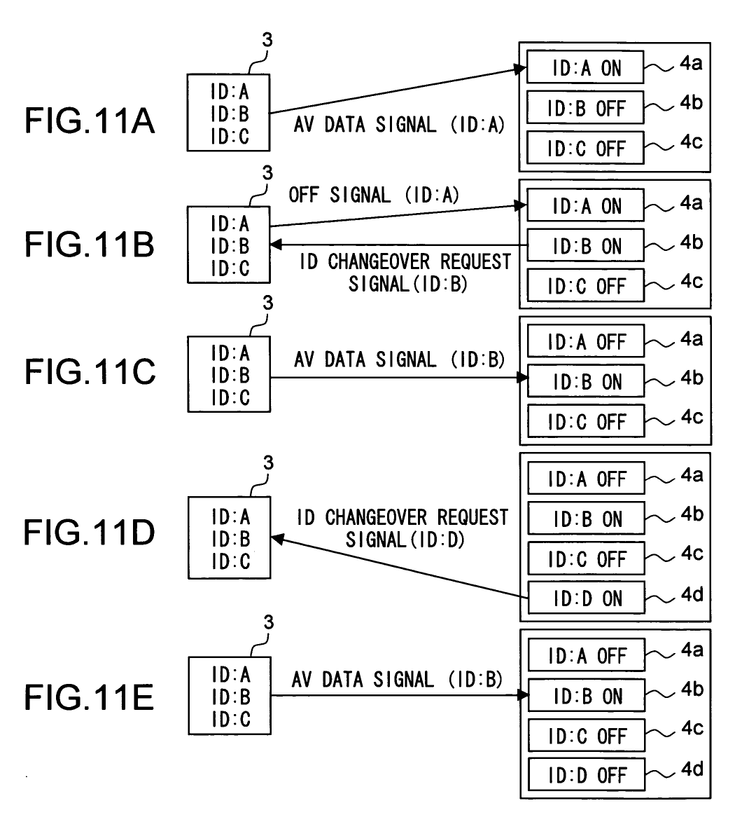

FIGS. 11A to 11E illustrate an example of the state transition of the AV data wireless communication system which occurs by interlocking the ID code changeover operation with the power ON/OFF operation of the AV data receiver 4 as described in this embodiment. First, as shown in FIG. 11A, when the AV data transmitter 3 encrypts the AV data signal 570 with the ID code A and transmits the encrypted ID code, only the AV data receiver 4a that stores the ID code A receives the AV data signal 570. At this moment, the AV reproduction apparatus 2a is in a power-ON state whereas the AV reproduction apparatuses 2b and 2c and the AV data receivers 4b and 4c are in power-OFF states.

Thereafter, as shown in FIG. 11B, when the AV data receiver 4b is turned on, the AV reproduction apparatus 2b is turned on and, in the bidirectional data communication period 582, the data signal 573 encrypted with the ID code B and serving as the ID changeover request signal is transmitted to the AV data transmitter 3. Accordingly, the AV data transmitter 3 decrypts this data signal 573 with the ID code B and changes over the ID code stored in the ID storage unit 520 to the ID code B. The ID code of the ID storage unit 520 is then temporarily changed to the ID code A which is the ID code before changeover, the OFF signal for turning off the AV data receiver 4a is encrypted with this ID code A and transmitted to the AD data receiver 4a.

Accordingly, as shown in FIG. 11C, the AV data receiver 4a receives the OFF signal encrypted with the ID code A, the AV reproduction apparatus 2a is turned off, and the AV data receiver 4a itself is turned off. The AV data transmitter 3 transmits the AV data signal 570 and the data signal 573 encrypted with the ID code B to the AV data receiver 4b.

While the AV data wireless communication is thus being held between the AV data transmitter 3 and the AV data receiver 4b, when the AV data receiver 4d that stores the ID code D is turned on, the AV data reproduction apparatus 2d is turned on, and the AV data receiver 4d transmits the data signal 573 encrypted with the ID code D and serving as the ID changeover request signal to the AV data transmitter 3 as shown in FIG. 11D, the AV data transmitter 3 cannot decrypt the data signal 573 with any of the ID codes A to C. Accordingly, it is recognized by the AV data transmitter 3 that the AV data receiver 4d is not the permitted receiver, and the ID code stored in the ID storage unit 520 is, therefore, kept being the ID code B. As a result, as shown in FIG. 11E, the AV data transmitter 3 and the AV data receiver 4b can continue the AV data wireless communication therebetween.

As described above, according to the third embodiment, by turning on the AV data receiver 4, the AV data receiver 4 can issue a request to change over the ID code stored in the ID storage unit 520 of the AV data transmitter 3 to the ID code stored in the ID storage unit 560 of the AV data receiver 4 for the purpose of data communication with the AV data transmitter 3. Therefore, by turning on the AV data receiver 4, data communication can be automatically established between the AV data receiver 4 and the AV data transmitter 3.

Further, when the ID changeover request is issued to the AV data transmitter 3 and the ID code stored in the ID storage unit 520 of the AV data transmitter 3 is changed, the AV data receiver 4 which has held the data communication with the AV data transmitter 3 before ID changeover can be turned off. Therefore, the AV data receiver 4 which has not held the data communication with the AV data transmitter 3 can be turned off, and power consumption in the AV data wireless communication system can be reduced.

In this embodiment, when the AV data receiver 4 does not hold the AV data wireless communication with the AV data transmitter 3, the AV data receiver 4 and the external devices such as the AV reproduction apparatus 2 are turned off. Alternatively, when the AV data receiver 4 receives the OFF signal, the AV data receiver 4 may set in a low power consumption mode such as a sleep state or a suspend state. Further, when the AV data receiver 4 receives the OFF signal, the AV data receiver 4 may be turned into an operation state in which the AV data receiver 4 can perform only the reception operation.

### Fourth Embodiment

Hereinafter, a fourth embodiment of the present invention will be described with reference to the drawings. An AV data wireless communication system, an AV data transmitter and an AV data receiver in this embodiment are constituted as shown in FIGS. 1, 2 and 30 or 7, respectively, similarly to the first to third embodiments.

The AV data wireless communication system in the fourth embodiment differs from those in the first to third embodiments in that after the AV data receiver 4 determines whether the ID code in the ID storage unit 520 of the AV data transmitter 3 can be changed to another ID code, the AV data receiver 4 issues the ID changeover request. It is noted that the AV data wireless communication system in this embodiment carries out the same ID changeover operation as that in the first or second embodiment. In addition, after the AV data transmitter 3 carries out the ID changeover operation, the AV data transmitter 3 operates according to the flowchart of FIG. 8 and the AV data receiver 4 (corresponding to one of the AV data receivers 4a to 4c) operates according to the flowchart of FIG. 9 similarly to the third embodiment.

Namely, when the AV data receiver 4 issues the ID changeover request to the AV data transmitter 3, the AV data transmitter 3 carries out the ID changeover operation according to the flowchart of FIG. 4 or 6. The AV data transmitter 3 transmits the OFF signal, and the AV data receiver 4, of which the AV data communication with the AV data transmitter 3 is disconnected, and the AV reproduction apparatus 2 (corresponding to one of the AV reproduction apparatuses 2a to 2c) are turned off.

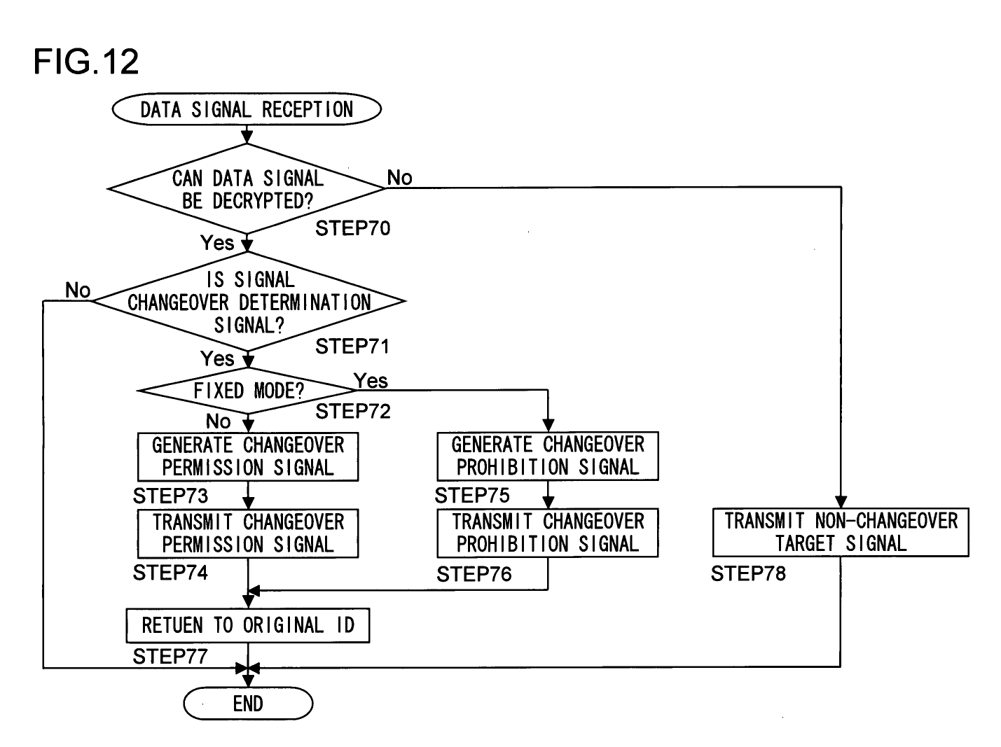

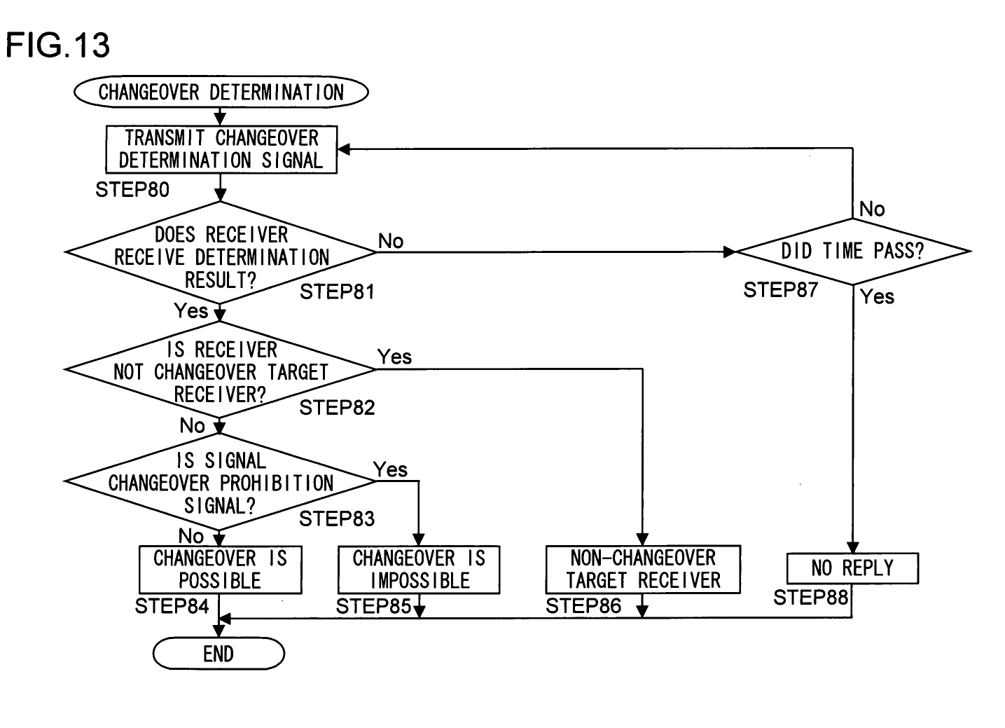

As described above, in the AV data wireless communication system in which the AV data transmitter 3 and the AV data receiver 4 carry out their ID changeover operations, the ID changeover determination operation for determining whether the ID changeover is possible is carried out. In this operation, the AV data transmitter 3 operates according to the flowchart of FIG. 12 and the AV data receiver 4 operates according to the flowchart of FIG. 13.

First, when a predetermined operation is carried out at the time of, for example, turning on the AV data receiver 4 or when the user operates the system, the AV data wireless communication system starts the ID changeover determination operation for determining whether the ID changeover operation is possible. The data generation unit 555 generates the ID changeover determination signal and the error correction code is added to the signal by the error correction code addition unit 556. The resultant signal is encrypted with the ID code stored in the ID storage unit 560 by the data scramble unit 557 and transmitted to the AV data receiver 4 through the BB 543, the RF 542 and the antenna 541 (STEP 80).

In addition, when the AV data transmitter 3 receives the data signal 573 through the antenna 511, the RF 510 and the BB 509 in the bidirectional data communication period 582, and the ID changeover control unit 521 can change over the ID code in the ID storage unit 520 to another ID code and it is determined whether the descramble unit 512 can descramble the data signal 573 with the changed ID code in the ID storage unit 520 (STEP 70).

In this case, similarly to the ID changeover operation shown in the flowchart of FIG. 4, the AV data transmitter 3 may determine whether the data signal 573 can be descrambled with the ID code stored in the ID storage unit 520 in the order of A→B→C. Alternatively, similarly to the ID changeover operation shown in the flowchart of FIG. 6, the AV data transmitter 3 may determine the data signal 573 can be descrambled with the ID code in the order starting with the ID code currently stored in the ID storage unit 520.

When the data analysis unit 513a determines that the received signal data 573 can be decrypted with any of the plural ID codes recorded in the ID changeover control unit 521 (Yes in STEP 70), it is determined whether this decrypted data signal 573 is the ID changeover determination signal (STEP 71). It is noted that when the data signal 573 is thus decrypted, the ID code used to decrypt the data signal 573 is temporarily stored in the ID storage unit 520. At this moment, when the data analysis unit 513a determines that the data signal 573 is the ID changeover determination signal (Yes in STEP 71), it is determined whether the user indicates that the ID code stored in the ID storage unit 520 cannot be changed (STEP 72).

To make the ID code in the ID storage unit 520 unchangeable, the state of the ID changeover control unit 521 is set. The state thus set will be referred to as “fixed mode”. The fixed mode may be designated by operating the ID changeover input unit 522 or by transmitting the control signal from the AV data receiver 4 with which the AV data transmitter 3 holds the AV data communication.

When it is determined that the AV data transmitter 3 is not in the fixed mode based on the state of the ID changeover control unit 521 (No in STEP 72), the data generation unit 505 generates the changeover permission signal indicating that the ID code in the ID storage unit 520 can be changed (STEP 73). After the error correction code addition unit 506 adds the error correction code to this changeover permission signal, the data scramble unit 507 encrypts the changeover permission signal with the ID code (used for the decryption in STEP 70) temporarily stored in the ID storage unit 520, and the encrypted signal is transmitted to the AD data receiver 4 through the BB 509, the RF 510 and the antenna 511 (STEP 74).

Conversely, when it is determined that the AV data transmitter 3 is in the fixed mode based on the state of ID changeover control unit 521 (Yes in STEP 72), the data generation unit 505 generates the changeover prohibition signal indicating the ID code in the ID storage unit 520 cannot be changed (STEP 75). Thereafter, similarly to STEP 74, the error correction code addition unit 506 adds the error correction code to this changeover prohibition signal, the data scramble unit 507 encrypts the signal with the ID code temporarily stored in the ID storage unit 520, and the encrypted signal is transmitted to the AV data receiver 4 through the BB 509, the RF 510 and the antenna 511 (STEP 76).

After the AV data transmitter 3 transmits the changeover permission signal in STEP 74 or the changeover prohibition signal in STEP 76, the ID changeover control unit 521 changes over the ID code temporarily stored in the ID storage unit 520 to the ID code stored therein before it is determined that the descramble unit 512 can descramble the data signal 573 with the ID code in the ID storage unit 520 in STEP 70 (STEP 77). As a result, when the ID code stored in the ID storage unit 520 is returned to the original state, the AV data transmitter 3 finishes the operation.

Further, it is determined that the descramble unit 512 cannot descramble the data signal 573 even with a plurality of ID codes recorded in the ID changeover control unit 521 (No in STEP 70), then the AV data transmitter 3 transmits the received signal, as a non-changeover target signal, to the AV data receiver 4 through the BB 509, the RF 510 and the antenna 511 so as to indicate that the AV data receiver 4 which transmits the signal received by the AV data transmitter 3 is a receiver for which the ID code cannot be changed over and which cannot hold the data communication with the AV data transmitter 3 (STEP 78) and the AV data transmitter 3 finishes the operation. It is assumed herein that the received signal is temporarily stored in the BB 509 until the operation according to the flowchart of FIG. 12 is finished.

When it is determined that the decrypted data signal 573 is not the ID changeover determination signal (No in STEP 71), the AV data transmitter 3 finishes the operation according to the flowchart of FIG. 12. At this time, the data analysis unit 513a determines a content of the decrypted data signal 573 and an operation according to the content is carried out. Namely, in the case where the decrypted data signal 573 is, for example, the ID changeover request signal, the AV data transmitter 3 moves to the operation according to the flowchart of FIG. 4 or 6 and determines whether the ID changeover control unit 521 permits the ID code changeover (STEP 3, STEP 8, STEP 13 or STEP 27). When it is determined that the ID changeover control unit 521 permits the ID code changeover, the ID code in the ID storage unit 520 is changed (STEP 4, STEP 9, STEP 14 or STEP 28).

At this moment, in the case where the signal is encrypted with the ID code other than the ID code stored in the ID storage unit 520 before the determination in STEP 70, the ID code in the ID storage unit 520 may be directly changed. Further, in the case where the signal is the retransmission request signal or the control signal for controlling the operation of the AV source device 1 encrypted with the ID code stored in the ID storage unit 520 before the determination in STEP 70, the AV data retransmission processing or the processing for controlling the AV source device 1 is carried out.

As described above, when the AV data transmitter 3 transmits the changeover permission signal, the changeover prohibition signal or the non-changeover target signal which is the determination result signal, the AV data receiver 4 determines whether the AV data receiver 4 has received the determination result signal from the AV data transmitter 3 (STEP 81). When the AV data receiver 4 has received the determination result signal through the antenna 541, the RF 542 and the BB 543 (Yes in STEP 81), the descramble unit 544 descrambles the determination result signal with the ID code in the ID storage unit 560 and the data analysis unit 545 determines whether the determination result signal is the non-changeover target signal (STEP 82).

When the data analysis unit 545 determines that the determination result signal is not the non-changeover target signal (No in STEP 82), the data analysis unit 545 determines whether the signal is the changeover prohibition signal (STEP 83). When the data analysis unit 545 determines that the signal is not the changeover prohibition signal (No in STEP 83), the AV data receiver 4 displays a result indicating that the ID changeover is possible (STEP 84). When the data analysis unit 545 determines that the signal is the changeover prohibition signal (Yes in STEP 83), the AV data receiver 4 displays a result indicating that the ID changeover is impossible (STEP 85). When the data analysis unit 545 determines that the signal is the non-changeover target signal (Yes in STEP 82), the AV data receiver 4 displays a result indicating that the AV data receiver 4 is not an ID changeover target receiver (STEP 86).

When the AV data receiver 4 does not determine the AV data receiver 4 has received the determination result signal from the AV data transmitter 3 (No in STEP 81), the AV data receiver 4 determines whether a predetermined time passed since the changeover determination signal has been transmitted (STEP 87). When it is determined that the predetermined time did not pass (No in STEP 87), the processing returns to STEP 81 again, in which the AV data receiver 4 determines whether the AV data receiver 4 has received the determination result signal. When it is determined that the predetermined time passed (Yes in STEP 87), the AV data receiver 4 displays a result indicating that the AV data transmitter 3 does not transmit the determination result signal (STEP 88).

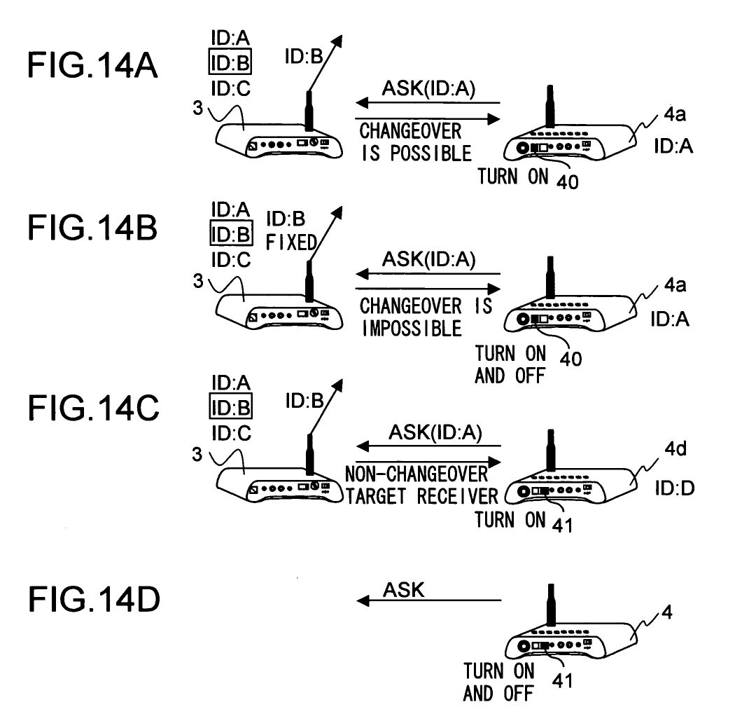

An operation example in which the AV data transmitter 3 and the AV data receiver 4 carry out their ID changeover determination operations will be described with reference to FIGS. 14A to 14D. First, as shown in FIG. 14A, when the AV data receiver 4a transmits the ID changeover determination signal ASK encrypted with the ID code A to the AV data transmitter 3 which includes the ID codes A to C and which is not in the fixed mode, the AV data transmitter 3 transmits the changeover permission signal to the AV data receiver 4a. Accordingly, the AV data receiver 4a receives the changeover permission signal, recognizes that the ID changeover is possible, and displays a result that the ID changeover is possible by turning on a light emission unit 40 such as an LED.

As shown in FIG. 14B, when the AV data transmitter 3 is in the fixed mode in which the ID code is fixed to the ID code B stored in the ID storage unit 520 and the AV data receiver 4a transmits the ID changeover determination signal ASK encrypted with the ID code A to the AV data transmitter 3, the AV data transmitter 3 transmits the changeover prohibition signal to the AV data receiver 4a. Accordingly, the AV data receiver 4a receives the changeover prohibition signal, recognizes that the AV data receiver 4a is a changeover target receiver but that the ID changeover is impossible, and turns on and off the light emission unit 40.

As shown in FIG. 14C, when the AV data receiver 4d which stores the ID code D transmits the ID changeover determination signal ASK encrypted with the ID code D to the AV data transmitter 3, the AV data transmitter 3 cannot decrypt the signal ASK because the signal is not encrypted with one of the ID codes A to C and transmits the non-changeover target signal. The AV data receiver 4d receives the non-changeover target signal, recognizes that the AV data receiver 4d is not the changeover target receiver, and turns on a light emission unit 41. Further, as shown in FIG. 14D, when the AV data receiver 4 does not receive the determination result signal from the AV data transmitter 3 after transmitting the ID changeover determination signal ASK, the AV data receiver 4 recognizes that there is no reply from the AV data transmitter 4 and turns on and off the light emission unit 41.

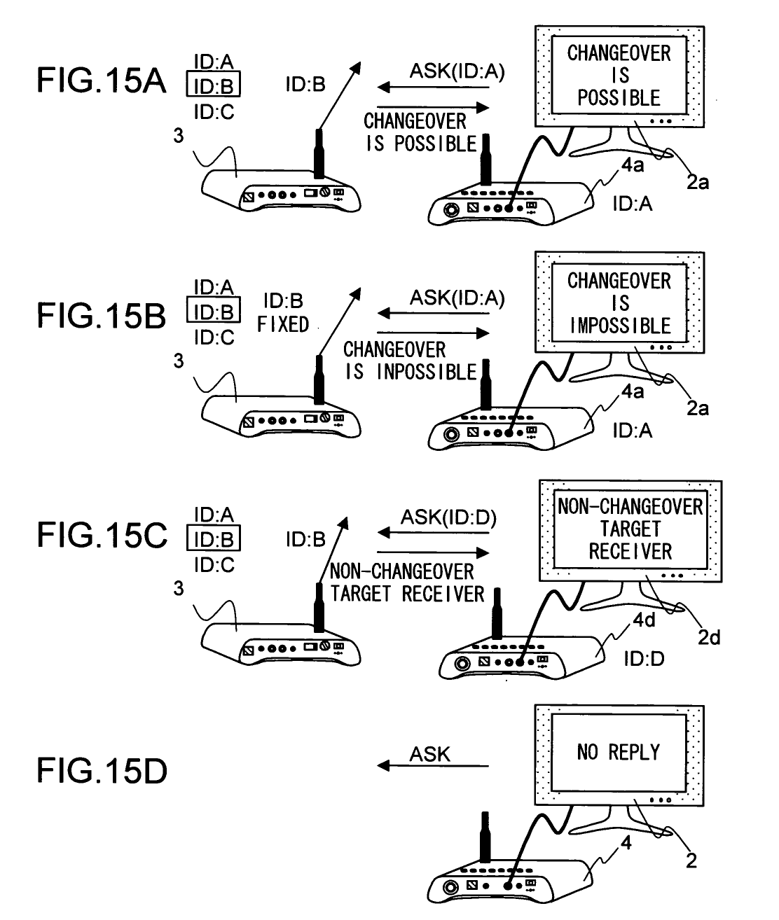

As described above, the light emission unit 40 or 41 may be provided on the AV data receiver 4 and the AV data receiver 4 may display the result indicating the state in one of STEP 84 to STEP 86 and STEP 88 in the flowchart of FIG. 13 according to the state of the light emission unit 40 or 41. Alternatively, as shown in FIGS. 15A to 15D, the result may be displayed by the AV reproduction apparatus 2 connected to the AV data receiver 4.

That is, in the state shown in FIG. 14A, the result indicating that the ID changeover is possible is displayed by the AV reproduction apparatus 2a connected to the AV data receiver 4a as shown in FIG. 15A. In the state shown in FIG. 144B, the result indicating that the ID changeover is impossible is displayed by the AV reproduction apparatus 2a as shown in FIG. 15B. In the state shown in FIG. 14C, the result indicating that the AV data receiver 4 is not the changeover target receiver is displayed by the AV reproduction apparatus 2d connected to the AV data receiver 4d as shown in FIG. 15C. In the state shown in FIG. 14D, the result indicating that there is no reply from the AV data transmitter 3 is displayed by the AV reproduction apparatus 2 connected to the AV data receiver 4 as shown in FIG. 15D.

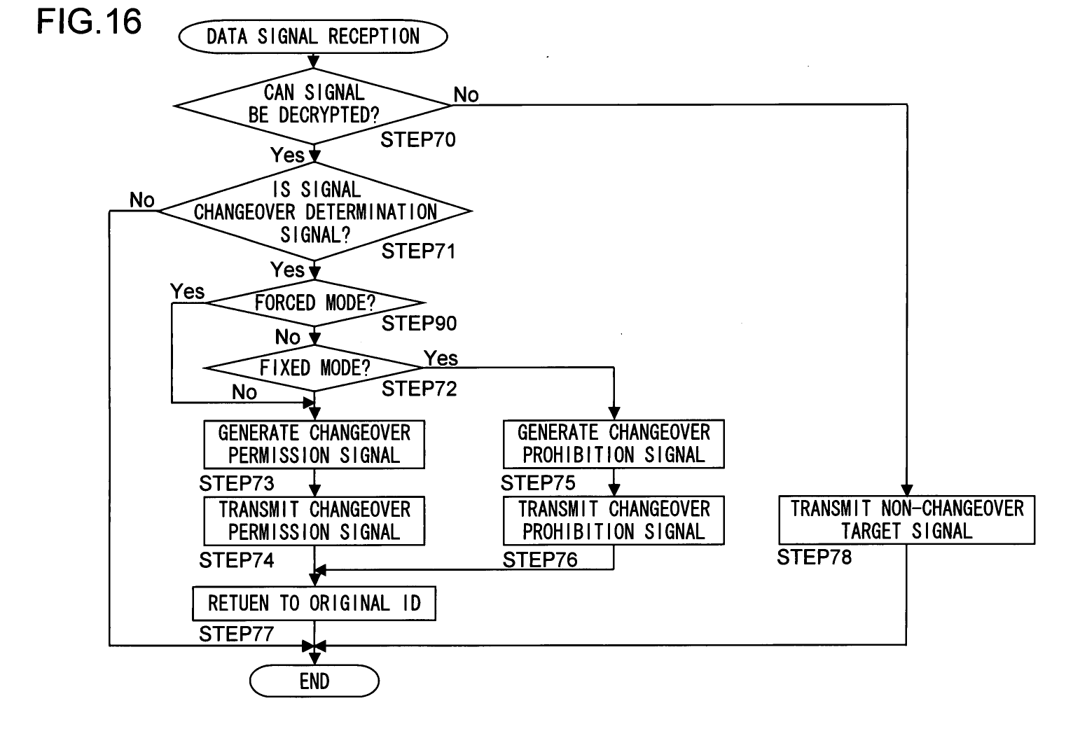

In this embodiment, when the AV data receiver 4 transmits the ID changeover determination signal, the data generation unit 555 may generate the ID changeover determination signal (serving as the ID changeover determination signal in a forced mode) including data for releasing the fixed mode of the AV data transmitter 3. In this case, the AV data transmitter 3 which determines whether ID changeover is possible operates according to the flowchart of FIG. 16.

More specifically, when it is determined that the received signal can be decrypted with the ID code recorded on the ID changeover control unit 521 in STEP 70 and that the decrypted signal is the ID changeover determination signal in STEP 71, the processing proceeds to STEP 90 in which it is determined that the ID changeover determination signal is the forced mode signal. When it is determined that the ID changeover determination signal is the forced mode signal (Yes in STEP 90), the processing proceeds to STEP 73 in which the processing operation when the ID code can be changed. When it is determined that the ID changeover determination signal is not the forced mode signal (No in STEP 90), the processing proceeds to STEP 72 in which it is determined whether the AV data transmitter 3 is in the fixed mode.

### Fifth Embodiment

Hereinafter, a fifth embodiment of the present invention will be described with reference to the drawings. An AV data wireless communication system, an AV data transmitter, and an AV data receiver in this embodiment are constituted as shown in FIGS. 1, 2, and 30 or 7, respectively, similarly to the fourth embodiment.

In the fifth embodiment similarly to the fourth embodiment, the system carries out the ID changeover determination operation and the ID changeover operation. Since the ID changeover operation is the same as that in the fourth embodiment, it will not be described herein. As for the ID changeover determination operation, differently from the fourth embodiment, the AV data transmitter 3 transmits a signal that indicates the AV data receiver 4 (corresponding to one of the AV data receivers 4a to 4c) with which the AV data transmitter 3 currently holds the AV data communication based on the ID code currently stored in the ID storage unit 520 and allows the AV data receiver 4 that transmitted the ID changeover determination signal to recognize the notification indicated by the signal.

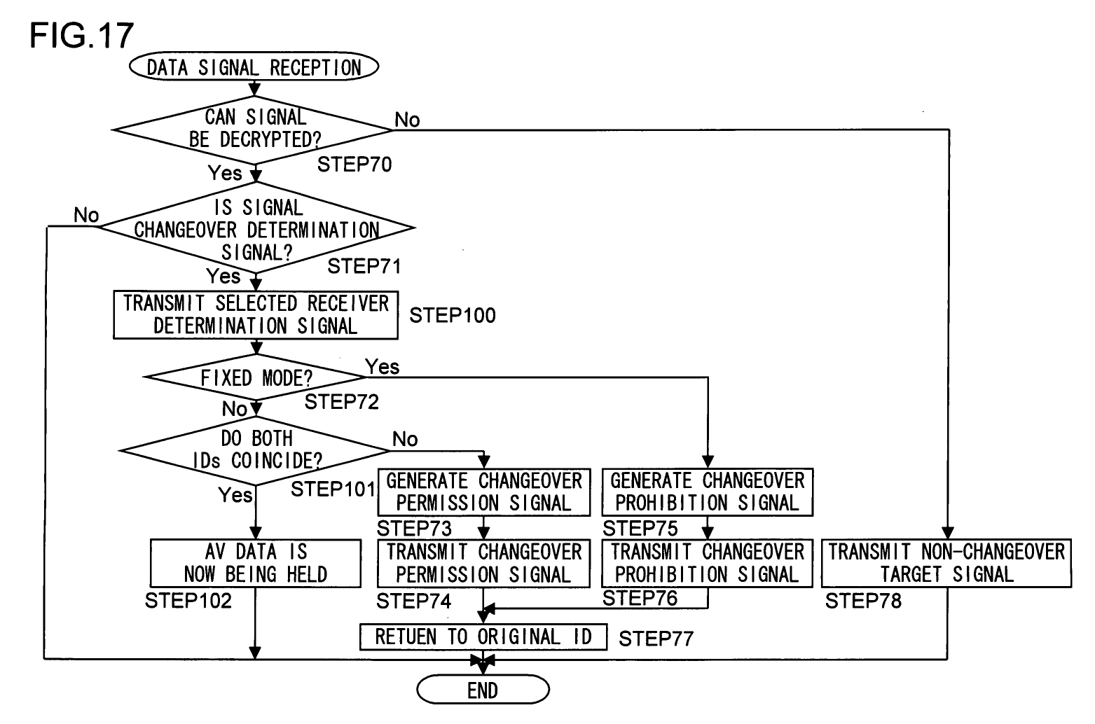

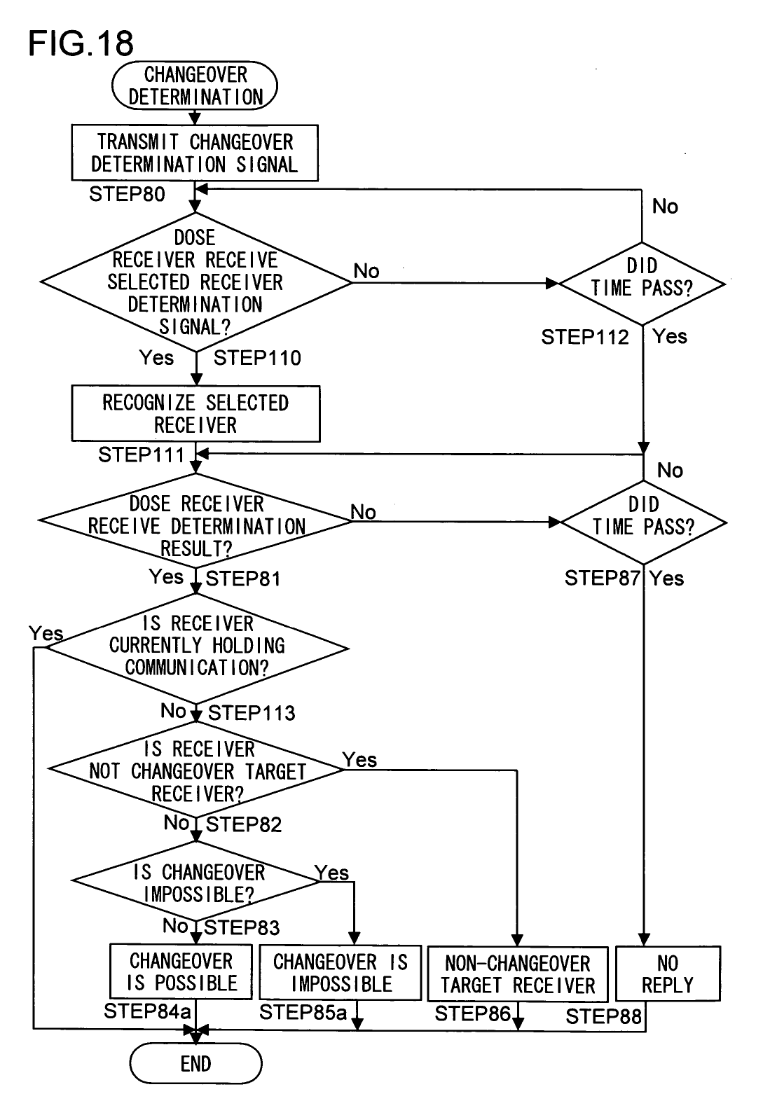

When the AV data wireless communication system carries out the ID changeover determination operation as described above, the AV data transmitter 3 operates according to a flowchart of FIG. 17 and the AV data receiver 4 operates according to a flowchart of FIG. 18. In the flowcharts of FIGS. 17 and 18, steps of carrying out the same operations as those in the flowcharts of FIGS. 12 and 13 are denoted by the same reference symbols and will not be described herein in detail.

First, when the predetermined operation is carried out, e.g., when the AV data receiver 4 is turned on, the user operates the AV data wireless communication system or the predetermined time passed since the previous ID changeover determination is finished, the AV data wireless communication system starts the ID changeover determination operation for determining whether the ID changeover is possible. The AV data receiver 4 transmits the ID changeover determination signal (STEP 80). The AV data transmitter 3 determines whether the data signal 573 received in the bidirectional data communication period 582 can be decrypted with the ID code recorded in the ID changeover control unit 521 (STEP 70). When it is determined that the data signal 573 can be decrypted (Yes in STEP 70), the AV data transmitter 3 determines whether the signal 573 is the ID changeover determination signal (STEP 71).

When the AV data transmitter 3 determines that the data signal 573 is the ID changeover determination signal (Yes in STEP 71), the AV data transmitter 3 determines the ID code stored in the ID storage unit 520 before determining that the data signal 573 can be decrypted in STEP 70, the data generation unit 505 generates a selected receiver determination signal indicating the AV data receiver 4 with which the AV data transmitter 3 currently holds the AV data communication, and the generated signal is transmitted to the AV data receiver (STEP 100). In this case, the error correction code addition unit 506 adds the error correction code to the selected receiver determination signal, the data scramble unit 507 encrypts the signal with the ID code determined in STEP 70, and the encrypted signal is transmitted to the AV data receiver 4 through the BB 509, the RF 510 and the antenna 511.

Thereafter, similarly to the fourth embodiment, it is determined whether the AV data transmitter 3 is in the fixed mode (STEP 72). When it is determined that the AV data transmitter 3 is not in the fixed mode (No in STEP 72), the ID code stored in the ID storage unit 520 before it is determined whether the data signal can be decrypted in STEP 70 is compared with the ID code with which the data signal was decrypted in STEP 70 (STEP 101). When a comparison result shows that the both ID codes are coincident (Yes in STEP 101), this indicates that the data signal is one transmitted form the AV data receiver 4 with which the AV data transmitter 3 currently holds the AV data communication and the AV data transmitter 3 transmits a signal indicating that the AV data communication is now being held (STEP 102).

When the comparison result shows that the both ID codes are not coincident (No in STEP 101), the AV data transmitter 3 carries out the operations in STEP 73, STEP 74 and STEP 77 and transmits the changeover permission signal to the AV data receiver 4. When it is determined that the AV data transmitter 3 is in the fixed mode (Yes in STEP 72), the AV data transmitter 3 carries out the operations in STEP 75 to STEP 77 and transmits the changeover prohibition signal to the AV data receiver 4. When it is determined that the data signal 573 cannot be decrypted (No in STEP 70), the AV data transmitter 3 carries out the operation in STEP 78 and transmits the non-changeover target signal to the AV data receiver 4.

After transmitting the changeover determination signal, the AV data receiver 4 determines whether the AV data receiver 4 receives the selected receiver determination signal (STEP 110). When the AV data receiver 4 receives the selected receiver determination signal through the antenna 541, the RF 542 and the BB 543 (Yes in STEP 110), the descramble unit 544 decrypts this selected receiver determination signal and the data analysis unit 545 determines the AV data receiver 4 with which the AV data transmitter 3 currently holds the AV data communication (STEP 111).

When the AV data receiver 4 does not receive the selected receiver determination signal, the AV data receiver 4 determines whether a predetermined time passed since transmitting the ID changeover determination signal (STEP 112). When it is determined that the predetermined time did not pass (No in STEP 112), the processing proceeds to STEP 110. When it is determined that the predetermined time passed (Yes in STEP 112), the processing proceeds to STEP 81 to determine whether the AV data receiver 4 has received the determination result signal.

Further, after determining the AV data receiver 4 with which the AV data transmitter 3 currently holds the AV data communication in STEP 111, the AV data receiver 4 determines whether the AV data receiver 4 has received the determination result signal (STEP 81). When it is determined that the AV data receiver 4 has received the determination result signal (Yes in STEP 81), the AV data receiver 4 determines whether the determination result signal is a signal indicating that the ID code of the AV data receiver 4 is stored in the ID storage unit 520 of the AV data transmitter 3 and that the AV data receiver 4 is currently holding the AV data communication with the AV data transmitter 3 (STEP 113). When the AV data receiver 4 is currently holding the AV data communication with the AV data transmitter 3 (Yes in STEP 113), the AV data receiver 4 finishes the ID changeover determination operation.

When it is determined that the AV data receiver 4 has received the changeover permission signal by performing the operations in STEP 82 and STEP 83, the AV data receiver 4 displays a notification that the ID changeover is possible as well as the number of the currently selected AV data receiver 4 (STEP 84a). When it is determined that the AV data receiver 4 has received the changeover prohibition signal, the AV data receiver 4 displays a notification that the ID changeover is impossible as well as the number of the currently selected AV data receiver 4 (STEP 85a). Further, when it is determined that the AV data receiver 4 has received the non-changeover target signal in STEP 82, the AV data receiver 4 displays a notification that the AV data receiver 4 is not the ID changeover target receiver (STEP 86). Further, when the AV data receiver 4 determines that the predetermined time passed but does not determine that the AV data receiver 4 has received the determination result signal in STEP 87, the AV data receiver 4 displays a notification that there is no reply from the AV data transmitter 3 (STEP 88).

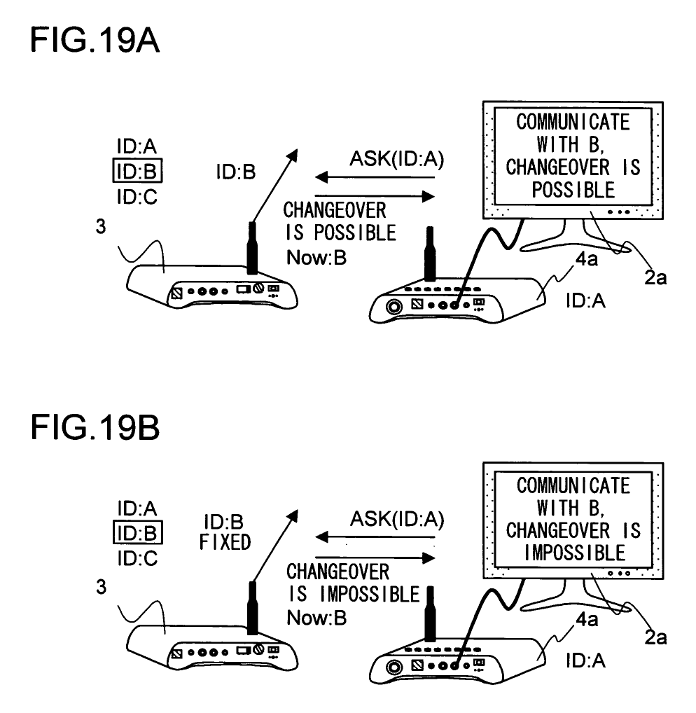

Therefore, as shown in FIG. 19A, when the AV data receiver 4a transmits the ID changeover determination signal ASK encrypted with the ID code A to the AV data transmitter 3 which includes the ID codes A to C, which has the ID code B stored in the ID storage unit 520, and which holds the AV data communication with the AV data receiver 4b, and the AV data transmitter 3 is not in the fixed mode, the AV data transmitter 3 transmits the selected receiver determination signal indicating that the AV data transmitter 3 is holding the AV data communication with the AV data receiver 4b and the changeover permission signal to the AV data receiver 4a.

The AV data receiver 4a recognizes that the AV data transmitter 3 is holding the AV data communication with the AV data receiver 4b and that the ID changeover is possible. The state of the AV data receiver 4a moves to the state in STEP 84a, and the AV data receiver 4a displays the notification that the ID changeover is possible and that the AV data transmitter 3 is holding the AV data communication with the AV data receiver 4b on the AV reproduction apparatus 2a connected to the AV data receiver 4a as shown in FIG. 19A.

As shown in FIG. 19B, while the AV data transmitter 3 is in the fixed mode in which the ID code is fixed to the ID code B stored in the ID storage unit 520, when the AV data receiver 4a transmits the ID changeover determination signal ASK encrypted with the ID code A to the AV data transmitter 3, the AV data transmitter 3 transmits the selected receiver determination signal indicating that the AV data transmitter 3 is holding the AV data communication with the AV data receiver 4b and the changeover prohibition signal to the AV data receiver 4a.

The AV data receiver 4a recognizes that the AV data transmitter 3 is holding the AV data communication with the AV data receiver 4b and that the ID changeover is impossible. The state of the AV data receiver 4a moves to the state in STEP 85b, and the AV data receiver 4a displays the notification that the ID changeover is impossible and that the AV data transmitter 3 is holding the AV data communication with the AV data receiver 4b on the AV reproduction apparatus 2a connected to the AV data receiver 4a as shown in FIG. 19B.

As shown in FIG. 15C, when the AV data receiver 4d which stores the ID code D transmits the ID changeover determination signal ASK encrypted with the ID code D to the AV data transmitter 3, the AV data transmitter 3 cannot decrypt the signal because the signal is not encrypted with one of the ID codes A to C and transmits the non-changeover target signal to the AV data receiver 4d. The AV data receiver 4d receives the non-changeover target signal, recognizes that the AV data receiver 4d is not the changeover target receiver, and the state of the AV data receiver 4d moves to the state in STEP 86. The AV data receiver 4d then displays a notification that the AV data receiver 4d is not the changeover target receiver on the AV reproduction apparatus 2d connected to the AV data receiver 4d.

As shown in FIG. 15D, when the AV data receiver 4 has not received the determination result signal from the AV data transmitter 3 since the AV data receiver 4 transmitted the ID changeover determination signal Ask to the AV data transmitter 3, the AV data receiver 4 recognizes that there is no reply from the AV data transmitter 3. Therefore, the state of the AV data receiver 4 moves to the state in STEP 88 and, as shown in FIG. 15D, the AV data receiver 4 displays the notification that there is no reply from the AV data transmitter 3 on the AV reproduction apparatus 2 connected to the AV data receiver 4.

Alternatively, in the fifth embodiment, when the AV data receiver 4 transmits the ID changeover determination signal to the AV data transmitter 3, the data generation unit 555 of the AV data receiver 4 may generate the ID changeover determination signal in the forced mode similarly to the fourth embodiment.

### Sixth Embodiment

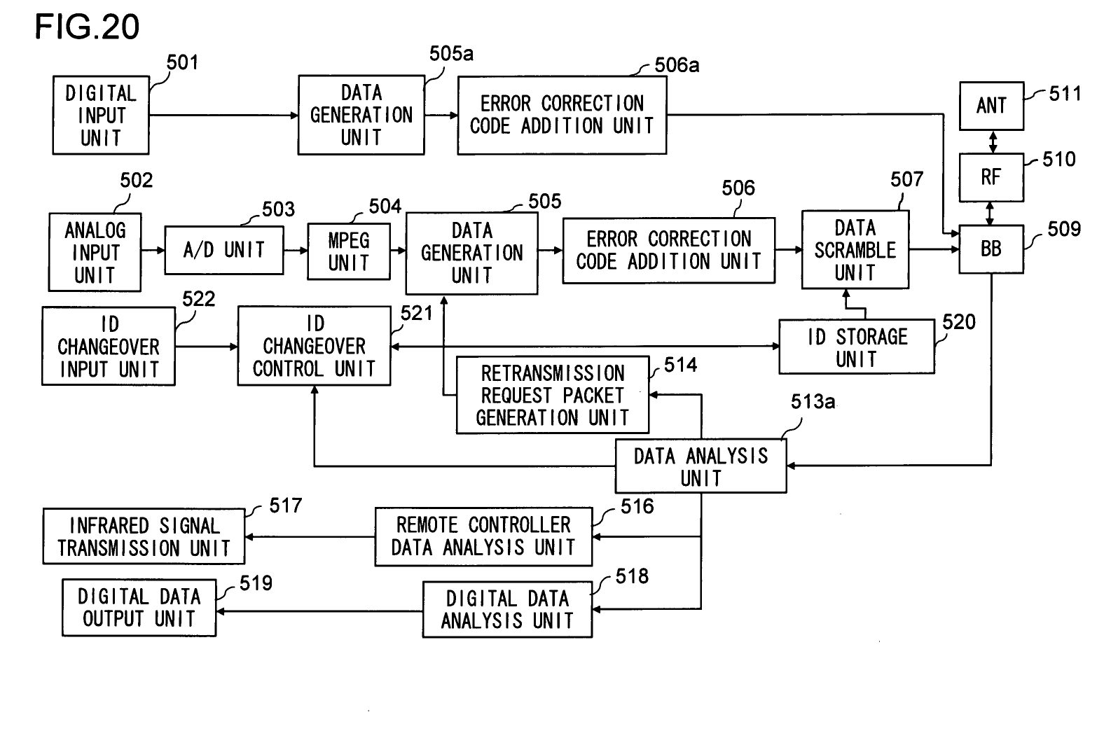

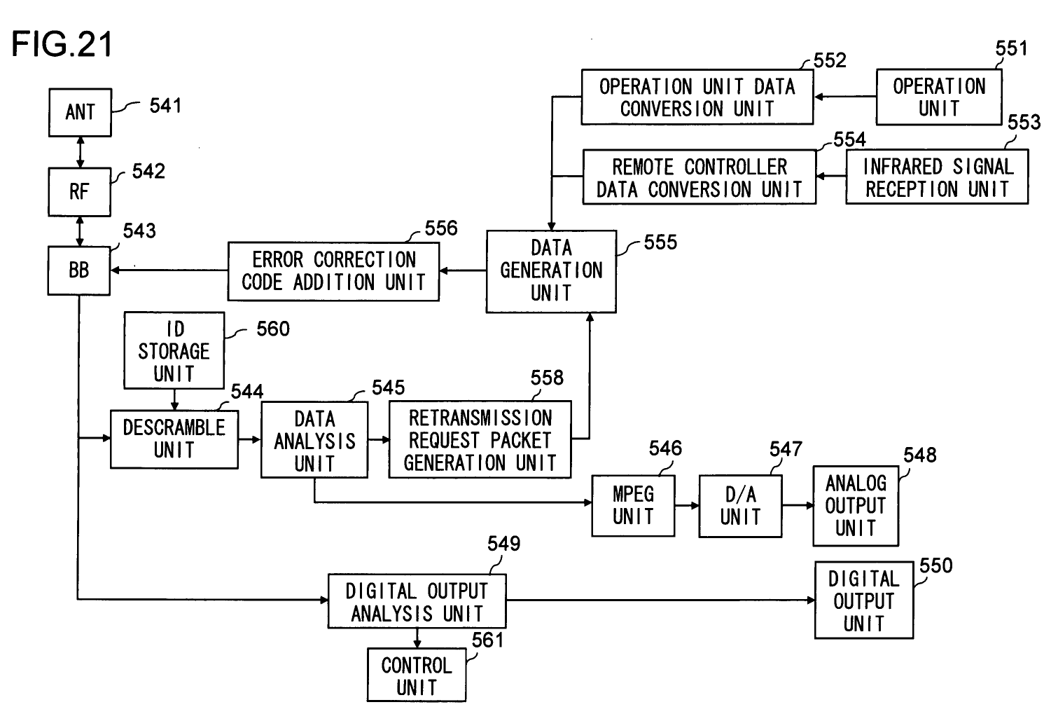

Hereinafter, a sixth embodiment of the present invention will be described with reference to the drawings. An AV data wireless communication system in this embodiment is equal in configuration to that shown in FIG. 1 similarly to the first to fifth embodiments. An AV data transmitter and an AV data receiver in this embodiment are constituted as shown in FIGS. 20 and 21, respectively. In the AV data transmitter shown in FIG. 20, constituent elements used for the same purposes as those for the constituent elements of the AV data transmitter shown in FIG. 2 are denoted by the same reference symbols, respectively, and will not be described herein in detail. In the AV data receiver shown in FIG. 21, constituent elements used for the same purposes as those for the constituent elements of the AV data receiver shown in FIG. 7 are denoted by the same reference symbols, respectively, and will not be described herein in detail.

The AV data wireless communication system in the sixth embodiment, differently from the first to fifth embodiments, is constituted so that the data signal 573 transmitted/received in the bidirectional data communication period 582 is not encrypted with the ID code. The AV data transmitter 3 shown in FIG. 20, differently from that shown in FIG. 2, is constituted so that the descramble unit 512 is not provided, so that the data analysis unit 513a is directly connected to the BB 509, and so that a data generation unit 505a connected to the digital input unit 501 and an error correction code addition unit 506a which adds the error correction code to the data from the data generation unit 505a and which feeds the resultant data to the BB 509 are additionally provided.

The AV data receiver 4 (corresponding to one of the AV data receivers 4a to 4c) shown in FIG. 21 is constituted so that the data scramble unit 557 is not provided, so that the error correction code addition unit 556 is directly connected to the BB 543, and so that the digital output analysis unit 549 is directly connected to the BB 543.

When the AV data transmitter 3 and the AV data receiver 4 are constituted as described above, the data signal 573 transmitted/received in the bidirectional data communication period 582 is applied to the BB 509 from the digital input unit 501 through the data generation unit 505a and the error correction code addition unit 506a in the AV data transmitter 3. In addition, in the AV data receiver 4, the data signal 573 is applied to the BB 543 from the data generation unit 555 through the error correction code addition unit 556.

That is, differently from the first to fifth embodiments, the data signal 573 is not encrypted by the data scramble units 507 and 557, so that it is determined from which apparatus the data signal 573 is transmitted based on transmission-side information included in the header 574. Further, each of the BBs 509 and 549 determines whether the period is the unidirectional AV data transmission period 581 or the bidirectional data communication period 582, thereby determining that the received data is the AV data signal 570 or the data signal 573.

In the AV data transmitter 3, when the data generation unit 505a generates the data signal 573 based on the data inputted from the digital input unit 501, the error correction code addition unit 506a adds the error correction code to the generated data signal 573 and the resultant data signal 573 is transmitted through the BB 509, the RF 510 and the antenna 511. When the data signal 573 is received through the antenna 511, the received signal 573 is applied to the BB 509 through the RF 510. Since the period is the bidirectional data communication period 582, the AV data transmitter 3 determines that the signal is the data signal 573. In addition, the AV data transmitter 3 determines that the data signal is addressed to the AV data transmitter 3 based on the header 574 and feeds the received signal to the data analysis unit 513a. The data analysis unit 513a determines from which AV data receivers 4 the data signal 573 is transmitted based on the header 574 of the data signal 573.

In the AV data receiver 4, when the data generation unit 555 generates the data signal 573 based on the data inputted from the operation unit data conversion unit 552, the remote controller data conversion unit 554 and the retransmission request packet generation unit 558, the error correction code addition unit 556 adds the error correction code to the data signal 573, and the resultant data signal 573 is transmitted through the BB 543, the RF 542 and the antenna 541. When the AV data receiver 4 receives the data signal 573 through the antenna 541, the received data is applied to the BB 543 through the RF 542. Since the period is the bidirectional data communication period 582, the AV data receiver 4 determines that the signal is the data signal 573. In addition, the AV data receiver 4 determines that the data signal is addressed to the AV data receiver 4 based on the header 574 and feeds the received signal to the digital output analysis unit 549.

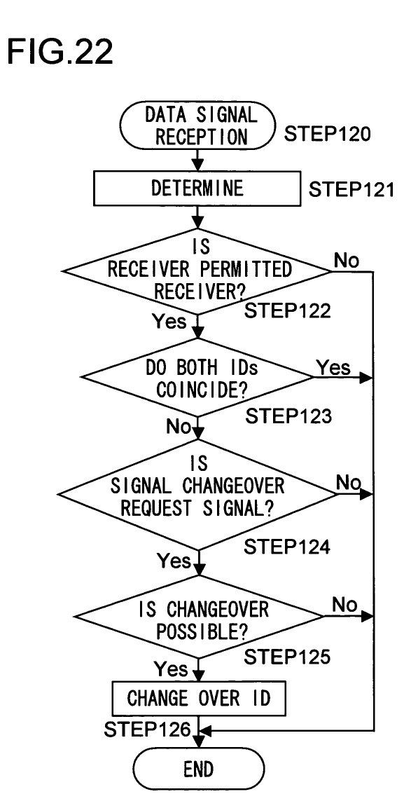

Accordingly, in the ID changeover operation, as shown in a flowchart of FIG. 22, when the AV data transmitter 3 receives the data signal 573 (STEP 120), the data analysis unit 513a determines from which apparatus the data signal 573 received by the AV data transmitter 3 is transmitted based on the header 574 of the data signal 573 (STEP 121). The AV data transmitter 3 then determines whether the determined receiver is the AV data receiver 4 permitted to hold data communication with the AV data transmitter 3 (STEP 122). When a sender of the data signal 573 is the AV data receiver 4 permitted to communicate with the AV data transmitter 3 (Yes in STEP 122), it is then determined whether the data signal 573 is transmitted from the AV data receiver 4 which includes the ID code coincident with the ID code currently stored in the ID storage unit 520 (STEP 123).

When it is determined that the data signal 573 is not transmitted from the AV data receiver 4 currently holding the AV data communication with the AV data transmitter 3 (No in STEP 123), the AV data transmitter 3 determines whether the data signal 573 is the ID changeover request signal (STEP 124). When it is determined that the data signal 573 is the ID changeover request signal (Yes in STEP 124), the AV data transmitter 3 determines whether the ID changeover is possible (STEP 125). When it is determined that the ID changeover is possible (Yes in STEP 125), the AV data transmitter 3 converts the ID code stored in the ID storage unit 520 to the ID code of the AV data receiver 4 that has transmitted the data signal 573 (STEP 126) and finishes the operation.

When it is determined the AD data receiver 4 is not permitted to hold communication with the AV data transmitter 3 (No in STEP 122), when the data signal 573 is transmitted from the AV data receiver 4 currently holding the AV data communication with the AV data transmitter 3 (Yes in STEP 123), when the data signal 573 is not the ID changeover request signal (No in STEP 124) or when the ID changeover is impossible (No in STEP 125), the AV data transmitter 3 finishes the operation.

Accordingly, when the AV data transmitter 3 receives the ID change request signal, the data analysis unit 513a determines from which apparatus this ID change request signal is transmitted based on the header 574 of the signal. When the AV data transmitter 3 stores the ID codes A to C in the ID changeover control unit 521 and the determined receiver is one of the AV data receivers 4a to 4c, the AV data transmitter 3 determines whether ID changeover is possible. When it is determined that the ID changeover is possible, the AV data transmitter 3 changes the ID code stored in the ID storage unit 520 to the ID code of the AV data receiver 4.

Alternatively, similarly to the first embodiment, the AV data transmitter 3 may determine the AV data receiver 4 based on the header 574 while referring to the order of the ID codes stored in the ID changeover control unit 521. Similarly to the second embodiment, the AV data transmitter 3 may determine that the data signal is the changeover request signal by making the signal correspond to the ID code other than the currently used ID code. Similarly to the third embodiment, the AV data receiver 4 which has held the data communication with the AV data transmitter 3 before the ID changeover and the external devices connected to the AV data receiver 4 may be turned off or the ID changeover request signal may be transmitted from the AV data receiver 4 when the AV data receiver 4 is turned on. 101341 Further, when the AV data wireless communication system carries out the ID changeover determination operation, the AV data transmitter 3 operates according to the flowchart of FIG. 12 or 17 and the AV data receiver 4 operates according to the flowchart of FIG. 13 or 18 similarly to the fourth and fifth embodiments. Thus, when the AV data wireless communication system carries out the ID changeover determination operation, the AV data transmitter 3 determines whether the receiver which has transmitted the data signal 573 recognized by the header 574 is the AV data receiver 4 permitted to hold the AV data communication with the AV data transmitter 3 instead of determining whether the data signal can be decrypted with the ID code stored in the ID storage unit 520 in STEP 70 in the flowchart of FIG. 12 or 17. When the AV data wireless communication system is constituted to carry out the same operations as those in the first to fifth embodiments, the OFF signal, the selected receiver determination signal, and the ID changeover determination signal are not encrypted with the ID code similarly to the other data signal 573 such as the ID changeover request signal.

### Seventh Embodiment

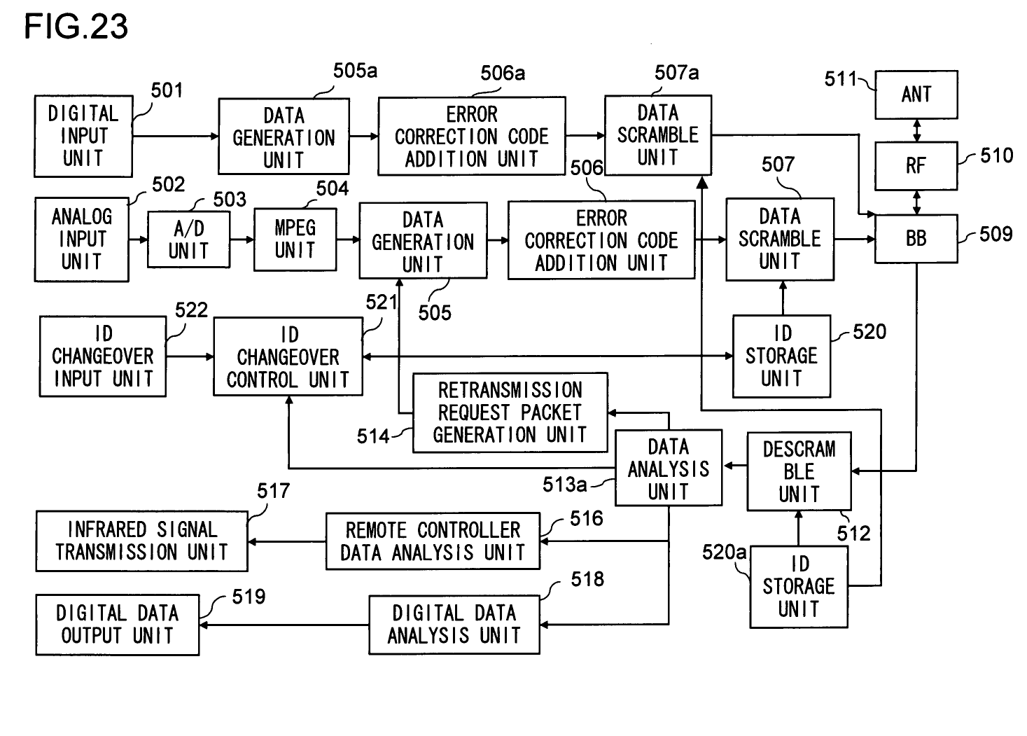

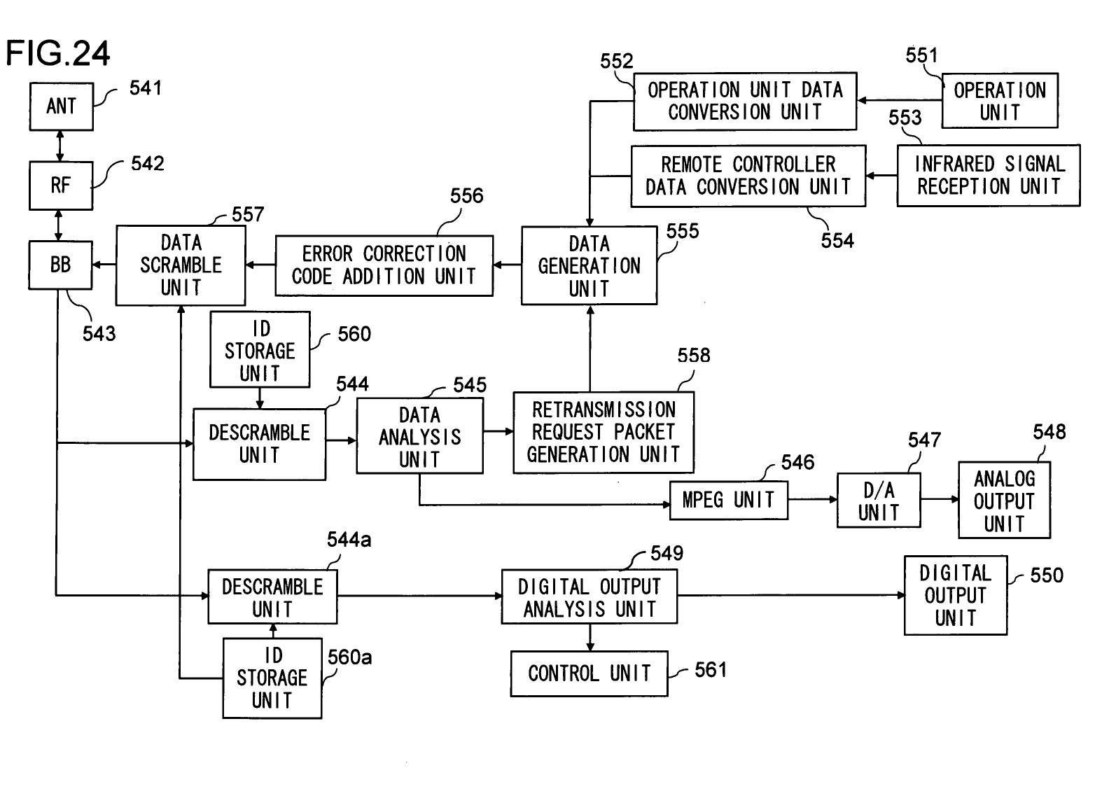

Hereinafter, a seventh embodiment of the present invention will be described with reference to the drawings. An AV data wireless communication system in this embodiment is equal in configuration to that shown in FIG. 1 similarly to the first to sixth embodiments. An AV data transmitter and an AV data receiver in this embodiment are constituted as shown in FIGS. 23 and 24, respectively. In the AV data transmitter shown in FIG. 23, constituent elements used for the same purposes as those for the constituent elements of the AV data transmitter shown in FIG. 20 are denoted by the same reference symbols, respectively, and will not be described herein in detail. In the AV data receiver shown in FIG. 24, constituent elements used for the same purposes as those for the constituent elements of the AV data receiver shown in FIG. 21 are denoted by the same reference symbols, respectively, and will not be described herein in detail.

The AV data wireless communication system in the seventh embodiment, differently from the first to fifth embodiments, is constituted so that the data signal 573 transmitted/received in the bidirectional data communication period 582 is encrypted with a common ID code X. This ID code X is stored in each of the AV data transmitter 3 and the AV data receivers 4 (corresponding to the AV data receivers 4a to 4c) permitted to hold AV data communication with the AV data transmitter 3 by the AV data transmitter 3. That is, in the case where the AV data transmitter 3 permits the AV data receivers 4a to 4c to hold communication with the AV data transmitter 3 as seen in the AV data wireless communication system shown in FIG. 1, the ID code X stored in the AV data transmitter 3 is not stored in the AV data receivers 4 other than the AV data receivers 4a to 4c.

Herein, the AV data transmitter 3 shown in FIG. 23 differs from that shown in FIG. 20 by additionally including an ID storage unit 520a which stores the ID code X common to the AV data transmitter 3 and all the AV data receivers 4 permitted to hold communication with the AV data transmitter 3, a data scramble unit 507a which encrypts the data signal from the error correction code addition unit 506a with the ID code X stored in the ID storage unit 520a, and a descramble unit 512 which decrypts the data signal with the ID code X stored in the ID storage unit 520a. In addition, the AV data receiver 4 shown in FIG. 24 differs from that shown in FIG. 21 by additionally including an ID storage unit 560a which stores the ID code X common to the AV data transmitter 3, a data scramble unit 557 which encrypts the data signal from the error correction code addition unit 556 with the ID code X stored in the ID storage unit 560a, and a descramble unit 544a which decrypts the data signal with the ID code X stored in the ID storage unit 560a.

When the AV data transmitter 3 and the AV data receiver 4 are constituted as described above, the data signal 573 transmitted/received in the bidirectional data communication period 582 is applied to the data scramble unit 507a from the digital data input unit 501 through the data generation unit 505a and the error correction code addition unit 506a in the AV data transmitter 3. The data signal 573 is then encrypted with the ID code X stored in the ID storage unit 520a by the data scramble unit 507a and applied to the BB 509. In the AV data receiver 4, the data signal 573 is applied from the data generation unit 555 to the data scramble unit 557 through the error correction code addition unit 556. The data signal 573 is encrypted with the ID code X stored in the ID storage unit 560a by the data scramble unit 557 and applied to the BB 543.

That is, differently from the first to fifth embodiments, the data signal 573 is encrypted with the common ID code X common by the data scramble units 507a and 557. Therefore, based on the transmission-side information included in the header 574 of the data signal 573, it is determined from which apparatus the data signal 573 is transmitted. In addition, each of the BBs 509 and 543 determines whether the period is the unidirectional AV data transmission period 581 or the bidirectional data communication period 582, thereby determining that the received data is the AV data signal 570 or the data signal 573.

In the AV data transmitter 3, when the data generation unit 505a generates the data signal 573 based on the data inputted from the digital input unit 501, the error correction code addition unit 506a adds the error correction code to the generated data signal 573. The data scramble unit 507a encrypts the data signal 573 with the ID code X by reading out the ID code X from the ID storage unit 520a and transmits the encrypted data signal 573 through the BB 509, the RF 510 and the antenna 511.

Further, in the AV data transmitter 3, when the data signal 573 is received through the antenna 511, the data signal 573 is applied to the BB 509 through the RF 510. Since the period is the bidirectional data communication period 582, the AV data transmitter 3 determines that the received signal is the data signal 573 and that the data signal 573 is addressed to the AV data transmitter 3 based on the header 574, and feeds the data signal 573 to the descramble unit 512. The descramble unit 512 decrypts the data signal 573 with the ID code X by reading out the ID code X from the ID storage unit 520a, and feeds the decrypted data signal 573 to the data analysis unit 513a. The data analysis unit 513a determines from which AV data receiver 4 the data signal 573 is transmitted based on the header 574 of the data signal 573.

In the AV data receiver 4, when the data generation unit 555 generates the data signal 573 based on contents of the operation unit data conversion unit 552, the remote controller data conversion unit 554 and the retransmission request packet generation unit 558, the error correction code addition unit 556 adds the error correction code to the generated data signal 573. The data scramble unit 557 reads out the ID code X from the ID storage unit 560a, encrypts the data signal 573 with the ID code X, and transmits the encrypted data signal 573 through the BB 543, the RF 542 and the antenna 541.

Further, in the AV data receiver 4, when the data signal 573 is received through the antenna 541, the received data signal is applied to the BB 543 through the RF 542. Since the period is the bidirectional data communication period 582, the AV data receiver 4 determines that the received signal is the data signal 573 and that the data signal 573 is addressed to the AV data receiver 4 based on the header 574, and feeds the data signal 573 to the descramble unit 544a. The descramble unit 544a reads out the ID code X from the ID storage unit 560a, decrypts the data signal 573 with the ID code X, and feeds the decrypted data signal 573 to the digital output analysis unit 549.

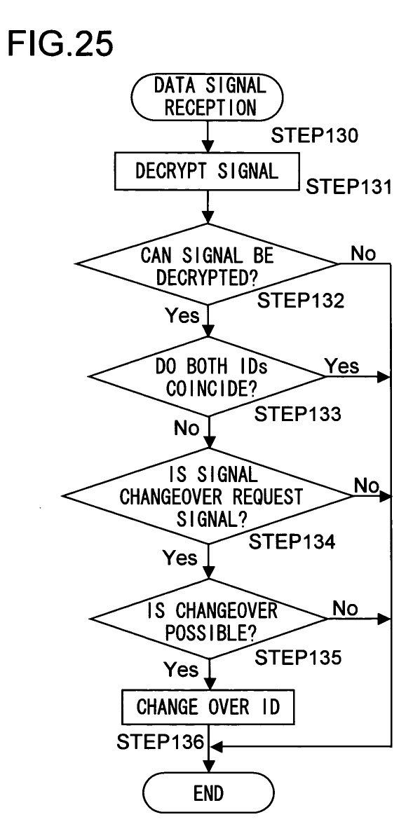

Therefore, in the ID changeover operation, as shown in a flowchart of FIG. 25, when the AV data transmitter 3 receives the data signal 573 (STEP 130), the received data signal 573 is applied to the descramble unit 512 and decrypted with the ID code X stored in the ID storage unit 520a by the descramble unit 512 (STEP 131). The data analysis unit 513a determines whether the data signal 573 is decrypted with the ID code X (STEP 132). When it is determined that the data signal 573 is decrypted with the ID code X (Yes in STEP 132), the data analysis unit 513a determines whether the data signal 573 is transmitted from the AV data receiver 4 which includes the ID code coincident with the ID code currently stored in the ID storage unit 520 based on the header 574 of the data signal 573 (STEP 133).

When the data signal 573 is not transmitted from the AV data receiver 4 with which the AV data transmitter 3 is currently holding AV data communication (No in STEP 133), it is determined whether the data signal 573 is the ID changeover request signal (STEP 134). When the data signal 573 is the ID changeover request signal (Yes in STEP 134), it is determined whether the ID changeover is possible (STEP 135). When it is determined that the ID changeover is possible (Yes in STEP 135), the ID code stored in the ID storage unit 520 is converted into the ID code of the AV receiver 4 which has transmitted the data signal 573 (STEP 136) and the AV data transmitter 3 finishes the operation.

When it is determined that the data signal 573 is not decrypted with the ID code X (No in STEP 132), when the data signal 573 is transmitted from the AV data receiver 4 with which the AV data transmitter 3 is currently holding the AV data communication (Yes in STEP 133), when the data signal 573 is not the ID changeover request signal (No in STEP 135) or when it is determined that the ID changeover is impossible (No in STEP 136), the AV data transmitter 3 finishes the operation.

As described above, when the AV data transmitter 3 receives the ID changeover request signal, the AV data transmitter 3 determines whether ID changeover is possible by determining whether the descramble unit 512 can decrypts the signal with the ID code X. When the ID changeover is possible, the data analysis unit 513a determines from which apparatus the ID changeover request signal has been transmitted based on the header 574 of the signal and the ID code stored in the ID storage unit 520 is changed. At this moment, similarly to the third embodiment, the AV data receiver 4 which has held the data communication with the AV data transmitter 3 before the ID changeover and the external devices connected to the AV data receiver 3 may be turned off or the ID changeover request signal may be transmitted from the AV data receiver 4 when the AV data receiver 4 is turned on.

Further, when the AV data wireless communication system carries out the ID changeover determination operation, the AV data transmitter 3 operates according to the flowchart of FIG. 12 or 17 and the AV data receiver 4 operates according to the flowchart of FIG. 13 or 18 similarly to the sixth embodiment. At this moment, the AV data receiver 3 determines whether the data signal 573 can be decrypted with the ID code X in STEP 70 in the flowchart of FIG. 12 or 17. When the AV data wireless communication system is constituted to carry out the same operations as those in the first to fifth embodiments, the OFF signal, the selected receiver determination signal and the ID changeover determination signal are encrypted with the ID code X similarly to the other data signal 573 such as the ID changeover request signal.

### Eighth Embodiment

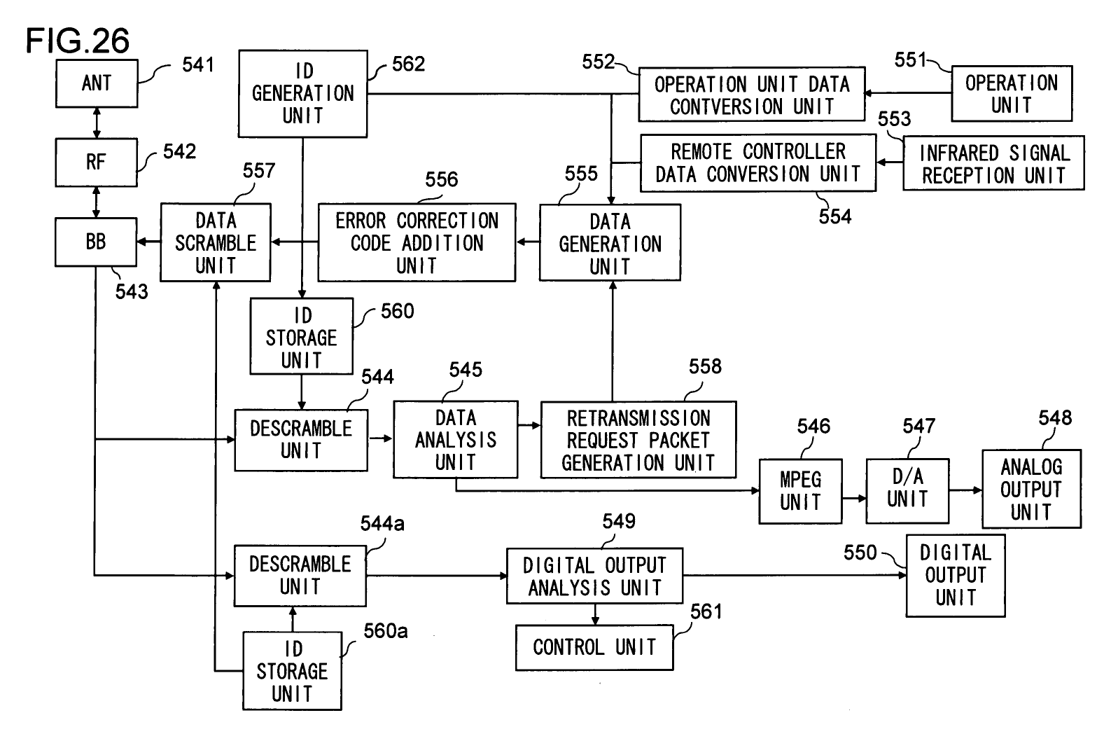

Hereinafter, an eighth embodiment of the present invention will be described with reference to the drawings. An AV data wireless communication system in this embodiment is equal in configuration to that shown in FIG. 1 similarly to the first to seventh embodiments. An AV data transmitter in this embodiment is constituted as shown in FIG. 23, similarly to the seventh embodiment. An AV data receiver in this embodiment is constituted as shown in FIG. 26. In the AV data receiver shown in FIG. 26, constituent elements used for the same purposes as those for the constituent elements of the AV data receiver shown in FIG. 24 are denoted by the same reference symbols, respectively, and will not be described herein in detail.

The AV data wireless communication system in the eighth embodiment, similarly to the seventh embodiment, is constituted so that the data signal 573 transmitted/received in the bidirectional data communication period 582 is encrypted with the common ID code X and so that ID code is changed to encrypt the AV data signal transmitted in the unidirectional AV data transmission period 581. That is, in the AV data wireless communication system in this embodiment, the AV data receiver 4 (corresponding to one of the AV data receivers 4a to 4c) additionally includes an ID generation unit 562 which changes the ID code as shown in FIG. 26 as well as the constituent elements shown in FIG. 24. Since the other constituent elements of the AV data receiver 4 are equal to those of the AV data receiver 4 in the seventh embodiment, they will not be described herein in detail.

Therefore, the operation of the AV data receiver during ID code change will be described. When the AV data receiver 4 is operated so as to change the ID code, the ID generation unit 562 generates an ID code. After the ID code generated by this ID generation unit 562 is applied to the data generation unit 555, the error correction code is added to the data signal by the error correction code addition unit 556, and the resultant data signal is fed to the data scramble unit 557.

After the data scramble unit 557 encrypts the data signal with the ID code X stored in the ID storage unit 560a, the encrypted data signal is transmitted as the data signal 573 in the bidirectional data communication period 582 through the BB 543, the RF 542 and the antenna 541. The data signal 573 thus transmitted is assumed as the ID change request signal. In addition, the ID code stored in the ID storage unit 560 is changed over to the ID code generated by the ID generation unit 562.

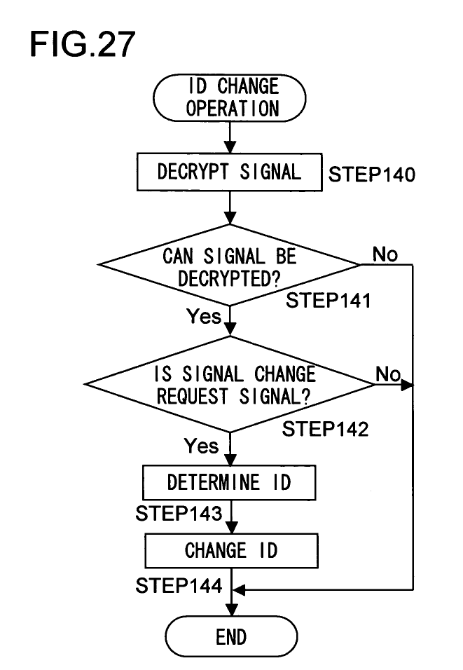

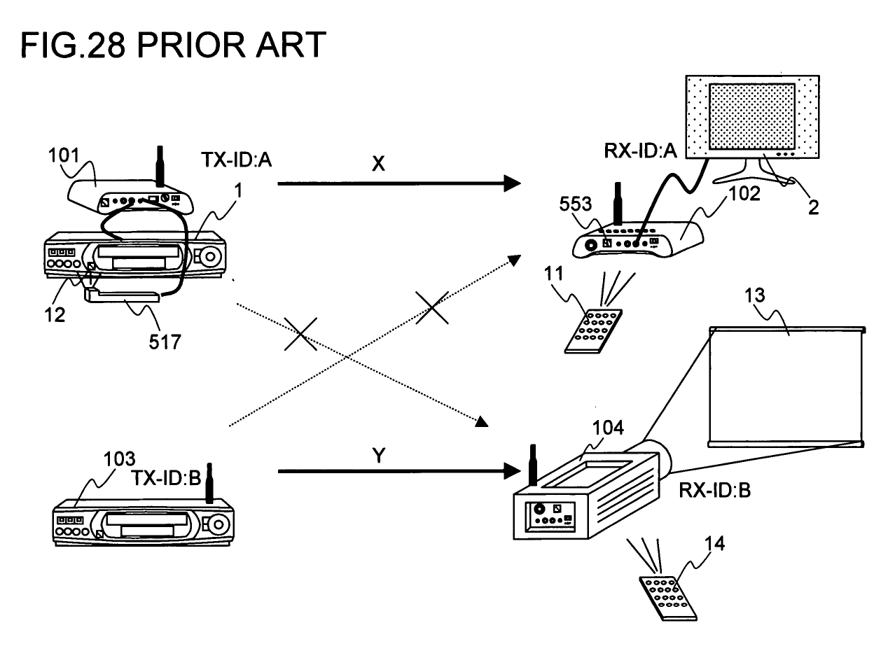

When the AV data receiver 4 transmits the ID change request signal that is the data signal 573 formed from the ID code changed over to the ID code generated by the ID generation unit 562, the AV data transmitter 3 receives the data signal 573 and determines that the AV data receiver 4 has changed the ID code. The operation of the AV data transmitter 3 at this moment will be described with reference to a flowchart of FIG. 27.

When the AV data transmitter 3 receives the data signal 573 through the antenna 511, the RF 510 and the BB 509, the data signal 573 is fed to the descramble unit 512 and decrypted with the ID code X stored in the ID storage unit 520a by the descramble unit 512 (STEP 140). The data analysis unit 513a determines whether the data signal 573 has been decrypted with the ID code X (STEP 141). When it is determined that the data signal 573 has been decrypted with the ID code X (Yes in STEP 141), the data analysis unit 513 determines from which data receiver 4 the signal has been transmitted based on the header 574 of the data signal 573 and whether the data signal 573 is the ID change request signal (STEP 142).

When the data signal 573 is the ID change request signal (Yes in STEP 142), the ID changeover control unit 521 determines the ID code of the AV data receiver 4 which is the sender of the data signal 573 (STEP 143). The ID code determined by the ID changeover control unit 521 is changed to the ID code determined by the ID change request signal (STEP 144), and the AV data transmitter 3 finishes the ID change operation. When the data signal 573 has not been decrypted with the ID code X (No in STEP 141) or when the data signal 573 is not the ID change request signal (No in STEP 142), the AV data transmitter 3 finishes the ID change operation.

When the ID code is changed in each of the AV data transmitter 3 and the AV data receiver 4 as described above, the AV data receiver 4 with which the AV data transmitter 3 holds AV data communication may be changed by carrying out the ID changeover operation as described in the seventh embodiment. Further, the ID change operation may be carried out simultaneously with the ID changeover determination operation or the ID changeover operation.

The first to eighth embodiments have been described while assuming that the AV data transmitter 3 and the AV data receivers 4a to 4c operate by operating the remote controller 5. Alternatively, by directly operating the AV data transmitter 3 and the AV data receivers 4a to 4c, the ID changeover operation, the ID changeover determination operation and the ID change operation may be carried out.

According to the present invention, the AV data transmitter manages the AV data receiver which can hold AV data communication with the AV data transmitter. Therefore, the number of AV data receivers which can receive the signal from the AV data transmitter can be limited to a specific number. In addition, since the AV data receiver which desires the reception of the AV data can request a key signal changeover, there is no need to operate apparatuses other than the AV data receiver which desires the reception of the AV data. Further, the operation state of the AV data receiver which finishes the AV data communication with the AV data transmitter is automatically changed simultaneously with the key signal changeover. For example, when the operation state of the AV data receiver is changed to an operation state which requires low power consumption, power consumption can be suppressed. In addition, since the connection relationship between the AV data transmitter and the AV data receiver can be notified by the AV data receiver or the AV reproduction apparatus, the user can easily check the connection relationship and connection state.

What is claimed is:

1. An AV data transmitter comprising:
a plurality of receiver key signals with each of which AV data including a voice and a picture is encrypted and each of which is set for each AV data receiver permitted to communicate with the AV data transmitter, wherein
the AV data transmitter selects one of the receiver key signals according to the AV data receiver, to which the AV data transmitter is to transmit the AV data, from among the plurality of receiver key signals as a data communication key signal, encrypts the AV data with the selected data communication key signal, and transmits the AV data to the AV data receiver.

2. The AV data transmitter according to claim 1, wherein
when the AV data transmitter receives a changeover request signal for requesting that the data communication key signal be changed over to one of the receiver key signals according to the AV data receiver from the AV data receiver, the AV data transmitter determines that the AV data receiver which has transmitted the changeover request signal is the AV data receiver permitted to communicate with the AV data transmitter, and
when the AV data receiver is the AV data receiver permitted to communicate with the AV data transmitter, the AV data transmitter changes over the receiver key selected as the data communication key signal to the one receiver key signal according to the AV data receiver and transmits the AV data encrypted with the correspondingly changed data communication key signal to the AV data receiver which has transmitted the changeover request signal.

3. An AV data transmitter comprising:
an encryption unit which encrypts AV data including a voice and a picture;
a first key signal storage unit which stores a data communication key signal used when the encryption unit encrypts the AV data;
a transmission/reception unit which transmits the AV data and which transmits/receives data; and
a key signal changeover control unit which stores a plurality of receiver key signals set according to a plurality of AV data receivers permitted to communicate with the AV data transmitter, respectively, and which changes over a data communication key signal in the first key signal storage unit, wherein
when the transmission/reception unit receives a changeover request signal for requesting that the data communication key signal be changed over to one of the receiver key signals according to one of the AV data receivers from the one AV data receiver, the AV data transmitter determines that the one AV data receiver which has transmitted the changeover request signal is one of the AV data receivers permitted to communicate with the AV data transmitter, and
when the one AV data receiver is one of the AV data receivers permitted to communicate with the AV data transmitter, the key signal changeover control unit changes over the receiver key selected as the data communication key signal stored in the first key signal storage unit to the one receiver key signal according to the one AV data receiver.

4. The AV data transmitter according to claim 3, further comprising:
a first decryption unit which decrypts the data received by the transmission/reception unit with the data communication key signal stored in the first key signal storage unit, wherein
the changeover request signal is encrypted with the one receiver key signal according to the one AV data receiver which transmits the changeover request signal, and
by determining with which of the plurality of receiver key signals stored in the key signal changeover unit the first decryption unit can decrypt the changeover request signal received by the transmission/reception unit, the AV data transmitter determines whether the one AV data receiver which has transmitted the changeover request signal is one of the AV data receivers permitted to communicate with the AV data transmitter.

5. The AV data transmitter according to claim 3, further comprising:
a second decryption unit which decrypts the changeover request signal encrypted with a specific key signal common to the AV data transmitter and the AV data receivers permitted to communicate with the AV data transmitter, wherein
by determining whether the second decryption unit can decrypt the changeover request signal received by the transmission/reception unit with the specific key signal, the AV data transmitter determines whether the one AV data receiver which has transmitted the changeover request signal is one of the AV data receivers permitted to communicate with the AV data transmitter.

6. The AV data transmitter according to claim 3, wherein
when the AV data transmitter receives the changeover request signal and changes over the data communication key signal, the transmission/reception unit transmits a state change signal for changing an operation state of the one AV data receiver which includes the one receiver key signal that is to serve as the data communication key signal stored in the first key signal storage unit as the data communication key signal until changing over the data communication key signal.

7. The AV data transmitter according to claim 3, wherein
the transmission/reception unit receives, from one of the AV data receivers, a change request signal for requesting that the receiver key signals stored in the key signal changeover control unit be changed, and
when the AV data transmitter determines that the one AV data receiver which has transmitted the change request signal is one of the AV data receivers permitted to communicate with the AV data transmitter, the AV data transmitter changes the receiver key signal according to the one respective AV data receivers and stored in the key signal changeover control unit to the receiver key signal recognized by the changeover request signal.

8. The AV data transmitter according to claim 3, wherein
the AV data transmitter has a fixed mode in which the data communication key signal stored in the first key signal storage unit cannot be changed over.

9. The AV data transmitter according to claim 8, wherein
assuming that a changeover determination signal for determining whether the data communication key signal in the first key signal storage unit can be changed over is transmitted from the one AV data receiver,, and that
the transmission/reception unit receives the changeover determination signal,
when the changeover determination signal is transmitted from the one AV data receiver permitted to communicate with the AV data transmitter and the AV data transmitter is not in the fixed mode, the transmission/reception unit transmits a communication permission signal indicating that the one AV data receiver can communicate with the AV data transmitter, and
when the changeover determination signal is transmitted from the one AV data receiver permitted to communicate with the AV data transmitter and the AV data transmitter is in the fixed mode, the transmission/reception unit transmits a communication prohibition signal indicating that the one AV data receiver cannot communicate with the AV data transmitter.

10. The AV data transmitter according to claim 9, wherein
when the transmission/reception unit receives the changeover determination signal, the AV data transmitter determines the AV data receiver that is currently transmitting the AV data based on the data communication key signal stored in the first key signal storage unit and transmits information on the one AV data receiver thus determined together with the communication permission signal or the communication prohibition signal.

11. The AV data transmitter according to claim 9, wherein
when the transmission/reception unit receives the changeover determination signal and the changeover determination signal is transmitted from an AV data receiver which is not permitted to communicate with the AV data transmitter, the AV data transmitter transmits a non-communication target signal indicating that the AV data receiver is not a communication target receiver.

12. The AV data transmitter according to claim 3, wherein
the AV data transmitter sets an AV data transmission period in which the AV data is transmitted for each cycle, and receives the changeover request signal in a period other than the AV data transmission period in the cycle.

13. An AV data receiver comprising:
a receiver key signal with which received AV data that is transmitted from an AV data transmitter and that includes a voice and a picture is decrypted, wherein
the AV data receiver transmits a changeover request signal for requesting that a key signal be changed over to the receiver key signal of the AV data receiver as a data communication key signal for encrypting the AV data, to the AV data transmitter which permits the AV data receiver to communicate with the AV data transmitter by storing the receiver key signal of the AV data receiver as one of a plurality of receiver key signals.

14. An AV data receiver comprising:
a transmission/reception unit which receives encrypted AV data such as a picture or a voice and which transmits/receives data;
a first decryption unit which decrypts the AV data;
a first key signal storage unit which stores a receiver key signal with which the first decryption unit decrypts the AV data; and
a data generation unit which generates the data to be transmitted, wherein
the data generation unit generates a changeover request signal for requesting that a key signal be changed over to the receiver key signal of the AV data receiver as a data communication key signal for encrypting the AV data, and the transmission/reception unit transmits the changeover request signal to the AV data transmitter which permits the AV data receiver to communicate with the AV data transmitter by storing the receiver key signal of the AV data receiver as one of a plurality of receiver key signals.

15. The AV data receiver according to claim 14, further comprising:
an encryption unit which encrypts the signal generated by the data generation unit with the receiver key signal stored in the first key signal storage unit, wherein
the changeover request signal generated by the data generation unit is encrypted with the receiver key signal by the encryption unit and transmitted from the transmission/reception unit.

16. The AV data receiver according to claim 14, further comprising:
an encryption unit which encrypts the signal generated by the data generation unit with a specific key signal common to the AV data transmitter and the AV data receiver permitted by the AV data transmitter to communicate with the AV data transmitter, wherein
the changeover request signal generated by the data generation unit is encrypted with the specific key signal by the encryption unit and transmitted from the transmission/reception unit.

17. The AV data receiver according to claim 16, further comprising:
a second decryption unit which decrypts a signal other than the AV data received by the transmission/reception unit with the specific key signal.

18. The AV data receiver according to claim 14, wherein
when the data communication key signal is changed over in the AV data transmitter and the AV data receiver receives the AV data from the AV data transmitter before the data communication key signal is changed over, the transmission/reception unit receives a state change signal for changing an operation state of the AV data receiver from the AV data transmitter and the operation state of the AV data receiver is changed.

19. The AV data receiver according to claim 18, wherein
when the transmission/reception unit receives the state change signal, the AV data receiver controls an operation state of an external device including an AV data reproduction apparatus, which reproduces the AV data and which is connected to the AV data receiver by a cable, to be changed.

20. The AV data receiver according to claim 14, wherein
when the AV data receiver is operated to be turned on, the data generation unit generates the changeover request signal, the transmission/reception unit transmits the generated changeover request signal, and an external device including an AV data reproduction apparatus, which reproduces the AV data and which is connected to the AV data receiver by a cable, is turned on.

21. The AV data receiver according to claim 14, further comprising:
a key signal generation unit which generates the receiver key signal, wherein
the receiver key signal generated by the key signal generation unit is applied to the data generation unit, the data generation unit generates a change request signal for requesting that the receiver key signal stored in the AV data transmitter be changed over to the receiver key signal generated by the key signal generation unit, and the transmission/reception unit transmits the generated change request signal.

22. The AV data receiver according to claim 14, wherein
the data generation unit generates a changeover determination signal for determining whether the data communication key signal of the AV data transmitter can be changed over, and the transmission/reception unit transmits the generated changeover determination signal.

23. The AV data receiver according to claim 22, further comprising:
a communication state determination unit which indicates that communication can be held when the transmission/reception unit receives a communication permission signal transmitted from the AV data transmitter and indicating that the communication can be held, and which indicates that the communication cannot be held when the transmission/reception unit receives a communication prohibition signal transmitted from the AV data transmitter and indicating that the communication cannot be held.

24. The AV data receiver according to claim 22, wherein
when the transmission/reception unit receives a communication permission signal transmitted from the AV data transmitter and indicating that communication can be held, the AV data receiver controls an AV reproduction apparatus connected to the AV data receiver by a cable so as to display a notification that the communication can be held, and
when the transmission/reception unit receives a communication prohibition signal transmitted from the AV data transmitter and indicating that communication cannot be held, the AV data receiver controls the AV reproduction apparatus so as to display a notification that the communication cannot be held.

25. The AV data receiver according to claim 24, wherein
the transmission/reception unit receives information representing the AV data receiver to which the AV data transmitter is currently transmitting the AV data as well as the communication permission signal or the communication prohibition signal, and the AV data receiver controls the AV reproduction apparatus so as to display the AV data receiver to which the AV data transmitter is currently transmitting the AV data.

26. The AV data receiver according to claim 23, wherein
when the transmission/reception unit receives a non-communication target signal indicating that the communication is prohibited from the AV transmitter which has received the changeover determination signal, the communication state determination unit shows that the AV data receiver is a non-communication target receiver.

27. The AV data receiver according to claim 24, wherein
when the transmission/reception unit receives a non-communication target signal indicating that the communication is prohibited from the AV transmitter which has received the changeover determination signal, the AV data receiver controls the AV reproduction apparatus so as to display the notification that the AV data receiver is a non-communication target receiver.

28. The AV data receiver according to claim 14, wherein
the AV data receiver sets an AV data transmission period in which the AV data is received for each cycle, and transmits the changeover request signal in a period other than the AV data transmission period in the cycle.

29. An AV data wireless communication system comprising:
an AV data transmitter which includes a plurality of receiver key signals with each of which AV data including a voice and a picture is encrypted and each of which is set for each AV data receiver permitted to communicate with the AV data transmitter, which selects one of the receiver key signals according to the AV data receiver to which the AV data transmitter is to transmit the AV data from among the plurality of receiver key signals as a data communication key signal, which encrypts the AV data with the selected data communication key signal, and which transmits the AV data to the AV data receiver; and
an AV data receiver which decrypts the AV data to be received.

30. The AV data wireless communication system according to claim 29, wherein
the AV data receiver transmits a changeover request signal for requesting that the data communication key signal be changed over to one of the receiver key signals according to the AV data receiver,
when the AV data transmitter receives the changeover request signal, the AV data transmitter determines that the AV data receiver which has transmitted the changeover request signal is the AV data receiver permitted to communicate with the AV data transmitter,
when the AV data transmitter determines that the AV data receiver which has transmitted the changeover request signal is the AV data receiver permitted to communicate with the AV data transmitter, the AV data transmitter changes over the receiver key selected as the data communication key signal to the one receiver key signal according to the AV data receiver, and
the AV data transmitter transmits the AV data encrypted with the correspondingly changed data communication key signal to the AV data receiver which has transmitted the changeover request signal.

31. The AV data wireless communication system according to claim 30, wherein
the changeover request signal is encrypted with the one receiver key signal.

32. The AV data wireless communication system according to claim 30, wherein
the changeover request signal is encrypted with a specific key signal common to the AV data transmitter and the AV data receiver permitted by the AV data transmitter to communicate with the AV data transmitter.

33. The AV data wireless communication system according to claim 29, wherein
when the AV data transmitter changes over the receiver key selected as the one data communication key signal to a first receiver key signal according to a first AV data receiver which has transmitted the changeover request signal,
then the AV data transmitter transmits a state change signal for changing an operation state of a second AV data receiver to the second AV data receiver so as to change the operation state of the second AV data receiver according to a second receiver key signal used as the data communication key signal before changeover, and
the second AV data receiver receives the state change signal and the operation state of the second AV data receiver is changed.

34. The AV data wireless communication system according to claim 33, wherein
by turning on the first AV data receiver, the changeover request signal is transmitted.

35. The AV data wireless communication system according to claim 29, wherein
the AV data receiver changes the one receiver key signal, generates and transmits a change request signal, including the receiver key signal as information, for requesting that the one receiver key signal in the AV data transmitter be changed, and
when the AV data transmitter receives the change request signal, the AV data transmitter changes the one receiver key signal stored according to the AV data receiver which has transmitted the change request signal to the receiver key signal determined by the change request signal.

36. The AV data wireless communication system according to claim 29, wherein
the AV data receiver transmits a changeover determination signal for determining whether the data communication key signal can be changed over, and
when the AV data transmitter which has received the changeover determination signal determines that communication can be held, the AV data transmitter transmits a communication permission signal indicating that the communication can be held, and when the AV data transmitter which has received the changeover determination signal determines that communication cannot be held, the AV data transmitter transmits a communication prohibition signal indicating that the communication cannot be held.

37. The AV data wireless communication system according to claim 36, wherein
when the AV data receiver, which has transmitted the changeover determination signal, is not the AV data receiver permitted to communicate with the AV data transmitter, the AV data transmitter which has received the changeover determination signal transmits a non-communication target signal indicating that the AV data receiver is not a communication target receiver.

38. The AV data wireless communication system according to claim 29, wherein
an AV data transmission period in which the AV data is transmitted/received for each cycle is set, and
the changeover request signal is transmitted/received in a period other than the AV data transmission period in the cycle.
